(19) United States
(12) Patent Application Publication
(10) Pub. No.: US 2025/0374388 A1
(43) Pub. Date: Dec. 4, 2025

(54) COOKING APPLIANCE WITH DIGITAL CONTROLLER DOOR AND METHOD FOR CONTROLLING COOKING APPLIANCE

(71) Applicant: LG Electronics Inc., Seoul (KR)

(72) Inventors: Dong Hun Kim, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/222,081

(22) Filed: May 29, 2025

(30) Foreign Application Priority Data
May 30, 2024 (KR) 10-2024-0070766
Dec. 16, 2024 (KR) 10-2024-0187290

(51) Int. Cl. H05B 6/64; G06F 3/147

(52) U.S. Cl. CPC H05B 6/6435; G06F 3/147

(57) ABSTRACT

A cooking appliance can include a main portion including a cavity for receiving food, and one or more functional components, the main portion being configured to provide a cooking function; a display door coupled to the main portion, the display door including a display to provide a user interface, and one or more door-mounted peripheral devices; a door controller configured to control an operation of the display door, and a main controller configured to control the main portion. Also, at least one of the door controller and the main controller is configured to monitor a communication between the main controller and the door controller, and perform an operation based on a communication error occurring between the main controller and the door controller.

### CROSS-REFERENCE TO RELATED APPLICATION

This application claims priority to and the benefit of Korean Patent Application No. 10-2024-0070766, filed on May 30, 2024, and Korean Patent Application No. 10-2024-0187290, filed on Dec. 16, 2024, in the Republic of Korea, the entireties of all these applications are incorporated herein by reference.

### BACKGROUND

### Field

The present disclosure relates to a cooking appliance including a digital controller door and a method for controlling the cooking appliance.

### Description of Related Art

A cooking appliance is a home appliance that cooks food using microwaves belonging to electromagnetic waves and/or heater heat. The cooking appliance can be generally provided with a cavity as a space in which food is placed and cooked, and a door for opening and closing the cavity.

When the cooking appliance is installed indoors, it is desirable to consider efficient use of the cooking appliance, saving of an installation space thereof, etc.

For this reason, the cooking appliance can be disposed at a position adjacent to a heating cooking device, for example, a heating oven, a gas stove, etc. Specifically, the cooking appliance can be disposed on top of the heating cooking device.

When the cooking appliance is disposed on top of the heating cooking device, the user can conveniently cook food by reducing the movement of the user in an environment in which the cooking appliance and the heating cooking device are adjacent to each other. In addition, heat, oil vapor, etc. as generated from the heating cooking device can be discharged to the outside using the cooking appliance as a hood.

In a state in which the cooking appliance is disposed on top of the heating cooking device, heat, oil vapor, or the like generated from the heating cooking device disposed under the cooking appliance can adversely affect the operation of the cooking appliance.

For example, a display can be mounted on a front surface of a door provided in the cooking appliance and can be configured to provide various information to the user. The user can know a cooking state of the cooked food through the display.

In addition, when the display is connected to another home appliance to serve as a hub of the home appliances, information other than cooking food can be obtained through the display. In addition, the user can input a command necessary for cooking and various other commands to the display in a touch manner.

In a state in which the cooking appliance is disposed on top of the heating cooking device, heat, oil vapor, etc. generated from the heating cooking device can invade into parts mounted on the display and the door.

It is desirable to suppress damage to or malfunction of the display of the cooking appliance and other components mounted on the door due to such heat, oil vapor, or the like.

The heat generated from the heating cooking device can rise under a convection to heat the display mounted on the cooking appliance, thereby causing the display to be damaged by the heat or causing a malfunction of the display.

Therefore, proper cooling is required so that the display does not become overheated. At least one fan device can be used to cool the display. However, when a large number of fan devices are used to cool the display or the fan device is rotated at an excessively high speed, noise of the fan device can make the user uncomfortable and excessive electricity can be consumed by the fan device.

A component for controlling the display and a component for controlling the operation of the cooking appliance operate in different operating manners. The component that controls the display can act as an information processing unit in that it interacts with the user. On the other hand, the cooking appliance can repeatedly perform a specific function.

Accordingly, a need exists for a scheme of defining a control of these two components or information flow manner therebetween and setting a process corresponding thereto so that the cooking appliance can be safely controlled in a normal operation and an abnormal operation situation.

### SUMMARY OF THE DISCLOSURE

Thus, the present disclosure has been devised to solve the above problem. A purpose of the present disclosure is to provide various software or hardware of a door coupled to the cooking appliance that cooperates smoothly with a control component for controlling the cooking appliance such that the cooking appliance can be safely controlled.

Further, a purpose of the present disclosure is to provide technology for controlling a cooking appliance and control component of a door coupled to the cooking appliance and a control component disposed in the cooking appliance that cooperate with each other.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

A cooking appliance including a digital controller door according to an embodiment of the present disclosure includes a functional unit (e.g., main body or main portion of the cooking appliance) configured to provide a cooking function, in which the functional unit includes a function controller for controlling an operation of the functional unit; and the digital controller door configured to provide a human interface, in which digital controller door includes an operating system (OS) controller for controlling the digital controller door, in which the function controller and the OS controller transmit or receive a packet to or from each other, in which the function controller or the OS controller is configured to restrict a function of the functional unit or a function of the digital controller door or to cancel a function being currently executed, based on a transmission and reception status of the packet between the function controller and the OS controller.

A method for controlling a cooking appliance including a digital controller door according to an embodiment of the present disclosure is provided. The cooking appliance includes: a functional unit configured to provide a cooking function, in which the functional unit includes a function controller for controlling an operation of the functional unit; and the digital controller door configured to provide a human interface, in which digital controller door includes an operating system (OS) controller for controlling the digital controller door. The method can include transmitting or receiving, by the function controller and the OS controller, a packet to or from each other; checking, by the function controller or the OS controller, a transmission and reception status of the packet; and restricting, by the function controller or the OS controller, a function of the functional unit or a function of the digital controller door, or cancelling, by the function controller or the OS controller, a function being currently executed, based on the transmission and reception status of the packet.

A cooking appliance including a digital controller door according to one embodiment of the present disclosure includes a functional unit configured to provide a cooking function; the digital controller door configured to provide a human interface; and a controller configured to control the functional unit and the digital controller door, in which the functional unit and the digital controller door transmit or receive a packet to or from each other, in which the controller is configured to restrict a function of at least one of the functional unit or the digital controller door or to cancel a function being currently executed, based on a transmission and reception status of the packet between the functional unit and the digital controller door.

A cooking appliance including a digital controller door according to one embodiment of the present disclosure includes a functional unit configured to provide a cooking function, in which the functional unit includes a function controller for controlling an operation of the functional unit; and the digital controller door configured to provide a human interface, in which digital controller door includes an operating system (OS) controller for controlling the digital controller door, in which the function controller and the OS controller transmit or receive a packet to or from each other, in which the function controller performs an immediate cancellation mechanism or the OS controller performs a suspended cancellation mechanism, based on a transmission and reception status of the packet between the function controller and the OS controller.

In accordance with the present disclosure, when an error occurs in various software or hardware of the door coupled to the cooking appliance, the operation of the cooking appliance can be controlled or canceled to increase stability of the cooking appliance.

In accordance with the present disclosure, the control component of the door coupled to the cooking appliance and the control component disposed in the cooking appliance can cooperate with each other to control the cooking appliance and solve the error occurring during the operation process of the cooking appliance.

The effects of the present disclosure are not limited to the above-described effects, and those skilled in the art can derive various effects of the present disclosure from the configuration of the present disclosure.

### BRIEF DESCRIPTION OF DRAWINGS

The above and other objects, features, and advantages of the present disclosure will become more apparent to those of ordinary skill in the art by describing example embodiments thereof in detail with reference to the attached drawings, which are briefly described below.

FIG. 1 is a conceptual diagram of a cooking appliance including a digital controller door according to an embodiment of the present disclosure.

FIG. 2 is a diagram illustrating components of a digital controller door and components of a functional unit according to an embodiment of the present disclosure.

FIG. 3 is a diagram illustrating categories of functions performed by an OS controller and a function controller according to an embodiment of the present disclosure.

FIG. 4 is a diagram showing a process for coping with an error that occurs while a function controller and an OS controller cooperate with each other according to an embodiment of the present disclosure.

FIG. 5 shows differentiated timing diagrams when an OS controller or a function controller performs monitoring according to an embodiment of the present disclosure.

FIG. 6 is a diagram showing an error response process when a function controller monitors an OS controller and an error occurs based on the monitoring result according to an embodiment of the present disclosure.

FIG. 7 is a diagram showing an error response process when a function controller monitors an OS controller and an error occurs based on the monitoring result according to another embodiment of the present disclosure.

FIG. 8 is a diagram showing an error response process when an OS controller monitors a function controller and an error occurs based on the monitoring result according to an embodiment of the present disclosure.

FIG. 9 is a diagram showing a process for adjusting, by a function controller, a normal state monitoring time duration or an error determination time duration according to an embodiment of the present disclosure.

FIG. 10 is a diagram showing a process for adjusting, by an OS controller, a normal state monitoring time duration or an error determination time duration according to an embodiment of the present disclosure.

FIG. 11 is a perspective view illustrating a cooking appliance according to an embodiment of the present disclosure.

FIG. 12 is a diagram illustrating a state in which a digital controller door is opened according to an embodiment of the present disclosure.

FIG. 13 is a perspective view illustrating a digital controller door of a cooking appliance according to an embodiment of the present disclosure.

FIG. 14 is a schematic view illustrating a position where a cooking appliance is disposed according to an embodiment of the present disclosure.

FIG. 15 is a diagram showing a configuration in which one controller controls a functional unit and a digital controller door according to an embodiment of the present disclosure.

FIG. 16 is a diagram showing a process in which a controller controls a function of a cooking appliance according to an embodiment of the present disclosure.

### DETAILED DESCRIPTION OF THE EMBODIMENTS

Hereinafter, embodiments of the present disclosure will be described in detail with reference to the drawings so that those skilled in the art to which the present disclosure pertains can easily implement the present disclosure. The present disclosure can be implemented in several different forms and is not limited to the embodiments described herein.

In order to clearly describe the present disclosure, parts irrelevant to the description are omitted, and the same reference numerals refer to the same or similar components throughout the specification. Further, some embodiments of the present disclosure will be described in detail with reference to the example drawings. In adding reference numerals to the components of each drawing, the same components can be denoted by the same reference numerals as much as possible even though the components are shown in different drawings. In addition, in describing the present disclosure, when it is determined that a detailed description of related known components or functions can obscure the gist of the present disclosure, the detailed description thereof can be omitted.

It will be understood that, although the terms “first,” “second,” “third,” and so on can be used herein to describe various components, areas, layers and/or units, these components, areas, layers and/or units should not be limited by these terms. These terms are used to distinguish one component, area, layer or unit from another component, area, layer or unit. Thus, a first component, area, layer or unit as described under could be termed a second component, area, layer or unit, without departing from the spirit and scope of the present disclosure. It will be understood that when a first component is referred to as being “connected to,” “jointed to” or “coupled to” a second component, the first component can be directly connected to or jointed to or coupled to the second component, or one or more intervening components can be present therebetween. In addition, it will also be understood that when a component is referred to as being “between” two components, it can be the only component between the two components, or one or more intervening components can also be present therebetween.

In addition, in the implementation of the present disclosure, the component can be subdivided for convenience of description. However, this component can be implemented in one device or module, or one component can be implemented to be distributed into a plurality of devices or modules.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

The present disclosure relates to a technique for controlling a cooking appliance using a digital controller door disposed at a front surface of the cooking appliance.

According to the present disclosure, a door of a microwave oven disposed on an oven or a gas stove can include an LCD or OLED screen. An Android operating system (OS) of the LCD or OLED screen and a microcomputer of the microwave oven cooperate with each other. An LCD or OLED component operates according to various operating/external environments of the microwave oven or controls a specific function of the microwave oven.

The digital controller door of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD or OLED screen providing various user interfaces such as a touch screen, and is capable of storing and cooking food therein. And embodiments of the present disclosure is not limited to a specific display panel type.

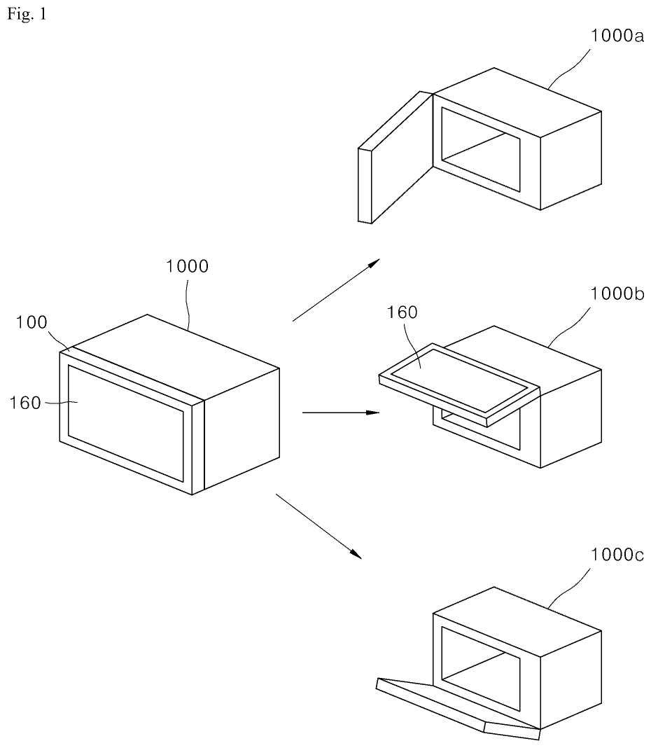

FIG. 1 is a conceptual diagram of a cooking appliance including a digital controller door according to an embodiment of the present disclosure.

The cooking appliance 1000 includes a digital controller door 100 at a front surface thereof. The digital controller door 100 includes one or two or more displays, and the display of the digital controller door 100 can display information about the inside of the cooking appliance 1000 or information related to an operation thereof to the user. The display of the digital controller door 100 can provide a touch input interface for receiving a predetermined command from the user.

A manner in which the digital controller door 100 is opened includes an embodiment 1000a, 1000b, or 1000c. 1000a shows an embodiment in which the digital controller door 100 pivots around a left side of the cooking appliance 1000a to open the right side of the cooking appliance 1000a, and open the inside of the cooking appliance 1000a. 1000b shows an embodiment in which the digital controller door 100 pivots around a top side of the cooking appliance 1000b to open the bottom side of the cooking appliance 1000b, and open the inside of the cooking appliance 1000b. 1000c shows an embodiment in which the digital controller door 100 pivots around a bottom side of the cooking appliance 1000c to open the top side of the cooking appliance 1000c, and open the inside of the cooking appliance 1000c.

A display 160 can be mounted on the front surface of the digital controller door 100 to provide various information to a user. The user can know the cooking state of the cooked food on the display 160. The display 160 can be embodied as an LCD. However, embodiments of the present disclosure are not limited thereto, and the display 160 can include various display panels. In addition, a touch panel for touch input can be coupled to the display 160.

The digital controller door 100 controls the operation of the cooking appliance 1000 and outputs various information. The cooking appliance 1000 performs cooking using microwaves or heater heat. Accordingly, a digital controlling function provided by the digital controller door 100 and a cooking function of the cooking appliance 1000 are provided in different ways and in different areas.

The digital controller door 100 of the present disclosure can serve as a kind of a hub (e.g., a smart hub or control center). That is, the digital controller door 100 can serve as a hub of another home appliance and display information transmitted from another home appliance on the display 160. In this process, the user can obtain other information other than the cooking food on the display 160. In addition, the user can input a command necessary for cooking and various other commands to the display 160 in a touch manner. For example, the user can use the digital controller door 100 to control and interact with other networked home appliances and smart devices. According to embodiments, the digital controller door 100 can be referred to as a smart door, a smart display door, a touchscreen door, a control hub door, or an integrated control panel door.

To this end, in accordance with the present disclosure, a method and a configuration in which the digital controller door 100 and the cooking appliance 1000 respectively include independent control components, and these control components cooperate with each other to control the function of the cooking appliance will be described.

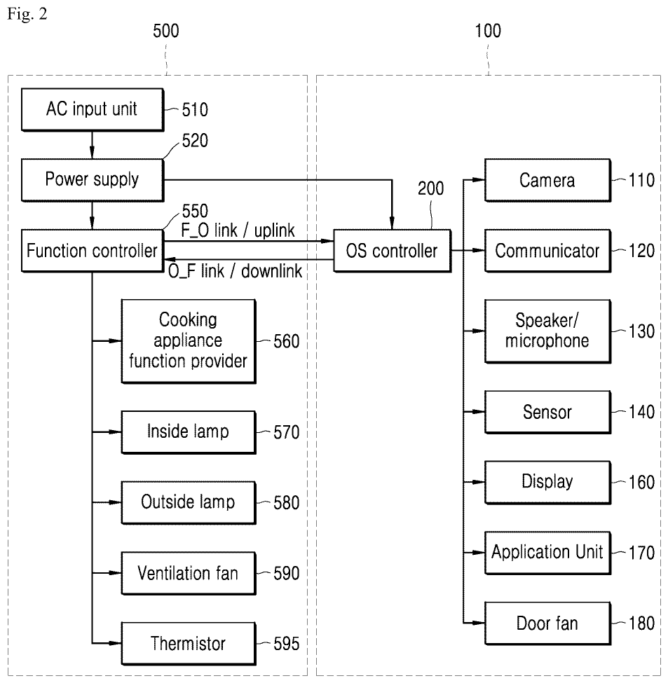

FIG. 2 is a diagram illustrating components of a digital controller door and components of a functional unit (e.g., a main body or main portion of the cooking appliance) according to an embodiment of the present disclosure. Each of the components is conceptually disposed and is not limited to a specific physical location or material.

The digital controller door 100 can operate as an Internet-of-things hub. The digital controller door 100 can include an OS controller 200. In addition, the digital controller door 100 can include a camera 110. In addition, the digital controller door 100 can include a communicator 120. In addition, the digital controller door 100 can include speaker/microphone 130. In addition, the digital controller door 100 can include a sensor 140. In addition, the digital controller door 100 can include the display 160. In addition, the digital controller door 100 can include an application unit 170. In addition, the digital controller door 100 can include a door fan 180. The door fan can be embodied as a direct current (DC) fan and cools the heat of the digital controller door 100. In particular, the door fan 180 cools heat generated from the display 160.

Hereinafter, the OS controller 200, the camera 110, the communicator 120, the speaker/microphone 130, the sensor 140, the display 160, the application unit 170, and the door fan 180 are referred to as elements or components of the digital controller door 100.

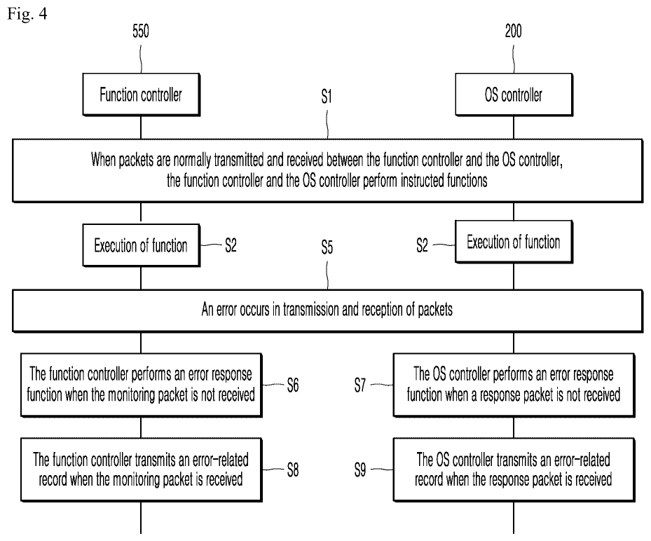

The functional unit 500 (e.g., main body or main portion) includes an AC input unit 510, a power supply 520, a function controller 550, a cooking appliance function provider 560 (e.g., magnetron, microwave generator, heater), an inside lamp 570, an outside lamp 580, a ventilation fan (vent fan) 590, etc. The functional unit 500 (e.g., main body) and the digital controller door 100 (e.g., smart door, or display door) are logically configured for the description of the present disclosure. The functional unit 500 can be implemented as a body 1010 illustrated in FIG. 4. For example, the functional unit 500 can be referred to as a main body or main portion of the cooking appliance. Accordingly, the functional unit 500 can further include various physical components necessary for implementation as the body 1010 in addition to the components illustrated in FIG. 2. According to an embodiment, the functional unit 500 can be referred to as a main body or body portion of a microwave or a cooking appliance, and the digital controller door 100 can be referred to a display door, a smart door or touchscreen door of the cooking appliance.

The OS controller 200 (e.g., display controller) controls various components of the digital controller door 100 (e.g., smart door, touchscreen door or door display, etc.). According to an embodiment, the OS controller 200 of the door can be referred to as a door controller and the function controller 500 can be referred to as a main controller. According to embodiments, the function controller 500 and the OS controller 200 can be referred to in various ways, such as main controller and sub-controller, first controller and second controller, system controller and display controller, or main controller and user interface UI controller, or variations thereof. For example, the controller in the cooking appliance can be referred to as a function controller 550 and the controller in the door can be referred to as display controller.

In addition, the OS controller 200 (e.g., in the door) transmits a predetermined signal to the function controller 550 (e.g., in the microwave oven), and allows the function controller 550 to control the performance of a specific function of the cooking appliance 1000. In addition, the function controller 550 can transmit a signal to the OS controller 200. This allows the function controller 550 to inform the OS controller 200 of a result related to the performance of a specific function of the cooking appliance 1000. The OS controller 200 can operate based on a specific operating system (OS) (e.g., Android). An Android operation system is merely an example, and other types of operating systems can be used, according to embodiments.

According to an embodiment, the function controller 550 and the OS controller 200 can operate independently and can communicate a predetermined signal with each other when there is information to be notified to each other. A type of signal can be based on various communication protocols such as wired communication or wireless communication. According to an embodiment, when the OS controller 200 receives information from the user and is instructed to perform a specific function of the cooking appliance, the OS controller 200 can transmit a specific signal to the function controller 550. In this situation, the function controller 550 operates the functional unit 500 (e.g., main body and components), for example, the body 1010.

The function controller 550 can be embodied as a microcomputer for generating a signal for operating the functional unit 500, for example, the body 1010.

The camera 110 can be disposed on the digital controller door to photograph the outside of the cooking appliance 1000, photograph the surroundings, or photograph a cooking space inside the cooking appliance 1000.

In addition, the camera 110 can be disposed inside the digital controller door 100. The camera 110 can photograph the inside of the cooking appliance 1000 to allow the user to check the cooking state of the food stored therein.

Accordingly, the camera 110 can be disposed to face outwardly of the digital controller door 100 (toward the user) and to face inwardly of the digital controller door 100 (toward the inside of the cooking appliance). In this situation, the display 160 can output an image obtained by photographing the outside out of the cooking appliance or the inside of the cooking appliance based on the cooking state or a state of the function performed by the digital controller door 100.

The communicator 120 (e.g., communication interface, or transceiver) can perform various types of wired or wireless communication functions. The communicator can communicate with another device (e.g., an external server, a hub disposed in a home, or another home appliance) using a communication protocol such as Wi-Fi, BLUETOOTH, or the like.

The speaker/microphone 130 can generate a voice, an alarm sound, etc. for the operation of the cooking appliance 1000, and can receive a predetermined external voice command or an external sound. The speaker/microphone 130 can be integral with each other or can be disposed at different positions.

The sensor 140 senses an environment outside or inside the cooking appliance 1000. For example, the sensor 140 can include a temperature sensor, an illuminance sensor, a human sensor, a humidity sensor, etc.

The display 160 outputs visual information to be provided to a user. The information provided from the display 160 includes a cooking function or state of the cooking appliance 1000 in operation, an interface for controlling the cooking appliance 1000, and information on a surrounding environment in which the cooking appliance 1000 is disposed.

In addition, when the digital controller door 100 operates as an Internet-of-things hub, the display 160 can display various information in addition to cooking related information. In addition, the display 160 can convert a user's touch into an input signal. For example, the display 160 can be a touchscreen display.

The application unit 170 (e.g., memory) stores therein various application programs as executed by the digital controller door 100, and the OS controller 200 can execute the application programs stored in the application unit 170 and can display the execution results on the display 160.

The door fan 180 embodied as the direct current fan is configured to cool heat generated in various electronic devices related to a digital controller door. The door fan 180 can cool the heat generated from the display 160 and/or the OS controller 200.

The OS controller 200 can download various application programs through the communicator 120 and store and install the application programs in the application unit 170.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this situation, the OS controller 200 can control a function of the cooking appliance 1000 by controlling the function controller 550 using the application program.

In addition, the application program according to an embodiment of the present disclosure includes an application program for the digital controller door 100 to operate as the Internet of Things hub.

The AC input unit 510 of the functional unit 500 (e.g., main body) receives power for the cooking appliance 1000 to operate. The supplied power is provided to the function controller 550 and the OS controller 200 through the power supply 520.

The function controller 550 controls the functions of the cooking appliance 1000. In this regard, the function controller 550 receives a signal from the OS controller 200 and controls the functions of the cooking appliance 1000. The function controller 550 can control an operation of each of the cooking appliance function provider 560 (e.g., magnetron, microwave generator, heating coil(s), heater), the inside lamp 570, the outside lamp 580, the ventilation fan (Vent Fan) 590, and the thermistor 595 according to the signal received from the OS controller 200. Hereinafter, the cooking appliance function provider 560, the inside lamp 570, the outside lamp 580, the ventilation fan 590, and the thermistor 595 are referred to as elements or components of the functional unit 500.

The cooking appliance function provider 560 (e.g., magnetron, microwave generator, heating coil(s), heater) generates microwaves or heat to cook food stored in the cooking appliance 1000.

The inside lamp 570 is disposed inside the cooking appliance 1000 that is opened and closed by the digital controller door 100. When the digital controller door 100 is opened or closed, the inside lamp 570 can be turned on and off. Alternatively, when the cooking appliance 1000 is cooking the food, the inside lamp 570 can be turned on so that the internal camera can capture an image thereof.

The outside lamp 580 is disposed at a lower end or an upper end of the cooking appliance 1000. When the cooking appliance 1000 is disposed on top of a separate cooktop, the outside lamp 580 can be disposed at a lower end of the cooking appliance 1000.

The ventilation fan 590 discharges heat generated from the cooktop to the outside.

The thermistor 595 is a component disposed in the functional unit 500 (e.g., main body and components) to sense a temperature. One or more thermistors 595 can be disposed at the cooking appliance 1000.

According to an embodiment of the present disclosure, the thermistor 595 can provide information on the sensed temperature to the function controller 550. According to another embodiment of the present disclosure, the thermistor 595 can be included in the sensor 140, and in this situation, information on the sensed temperature can be provided to the OS controller 200 that controls the sensor 140.

The food stored in the cooking appliance 1000 is cooked via the operation of the cooking appliance function provider 560. Even in this process, the function controller 550 and the OS controller 200 can communicate information with each other per a preset time interval.

The OS controller 200 provides a user interface/user experience (UI/UX) function. In addition, the OS controller 200 transmits a predetermined signal to the function controller 550, and the function controller 550 controls the operation of the cooking appliance 1000, for example, the body 1010 or the functional unit 500. In addition, the function controller 550 can control an operation of the cooking appliance function provider 560 and provide information generated therefrom during control to the OS controller 200.

Accordingly, the control flow of the OS controller 200 and the function controller 550 is configured such that the OS controller 200 transmits a predetermined signal to the function controller 550 and then receives a predetermined control result from the function controller 550. For example, the OS controller 200 in the door can monitor the function controller 550 in the body of the microwave/cooking appliance.

The OS controller 200 and the function controller 550 can communicate with each other in a wired or wireless manner. The OS controller 200 and the function controller 550 can communicate with each other using various communication protocols, and embodiments of the present disclosure are not limited to a specific communication protocol.

As illustrated in FIG. 2, a communication link via which the function controller 550 transmits predetermined data to the OS controller 200 or performs control is referred to as a F_O link or an uplink. A communication link via which the OS controller 200 transmits predetermined data to the function controller 550 or performs control is referred to as an O_F link or a downlink. However, embodiments of the present disclosure are not limited to a specific name or a direction such as upward/downward, and the links can be distinguished from each other based on a direction of data transmission between the components 550 and 200.

In an embodiment of the present disclosure, the link can physically use one or more lines or can use one or more communication media. In addition, in accordance with the present disclosure, a name is separately given to each data transmission direction in order to distinguish logically the data transmission directions from each other.

According to an embodiment of the present disclosure, in the situation of the wired communication, the OS controller 200 and the function controller 550 can communicate with each other using a communication protocol such as Universal asynchronous receiver/transmitter (UART) and Universal Serial Bus (USB).

According to an embodiment of the present disclosure, in the situation of the wireless communication, the OS controller 200 and the function controller 550 can communicate with each other using a communication protocol such as ZIGBEE, Wi-Fi, and BLUETOOTH.

Each of the OS controller 200 and the function controller 550 can include a separate memory (e.g., internal memory), and can store, in the memory, function result information or error information generated in the process of performing a function.

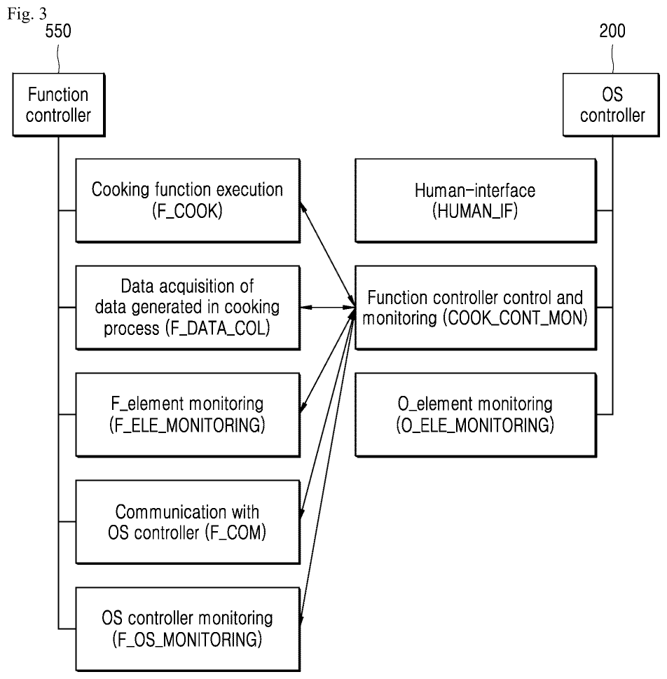

FIG. 3 is a diagram illustrating categories of functions performed by an OS controller and a function controller according to an embodiment of the present disclosure. Each function includes a situation in which each of the controllers 200 and 550 performs a corresponding function.

Each of the controllers 200 and 550 can perform the functions simultaneously or sequentially.

The function controller 550 controls the functional unit 500 that provides a cooking function. The operating system (OS) controller 200 transmits a signal to the function controller 550. The function controller 550 instructs an operation of the functional unit 500. The operating system (OS) controller 200 controls the digital controller door 100 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 200. In addition, functions performed by the function controller 550 include OS controller monitoring F_OS_MONITORING. The OS controller 200 and the function controller 550 can operate independently, and can inform the state or operation status of each component via transmission and reception of signals to and from each other.

In the cooking function execution F_COOK, the function controller 550 controls the cooking appliance function provider 560 so that the cooking appliance 1000 can perform cooking. Alternatively, in addition to cooking such as heating, a function in which the function controller 550 controls the operation of the inside lamp 570, the outside lamp 580, and the ventilation fan 590 can be included in the cooking function execution F_COOK.

The function of the data acquisition F_DATA_COL of the data generated in the cooking process is a function of the function controller 550 collecting or acquiring various result values calculated by the elements or the components of the functional unit 500 or data related to the current state in the cooking function execution F_COOK process.

The F_element monitoring F_ELE_MONITORING refers to a function in which the function controller 550 monitors elements or components of the functional unit 500. The function controller 550 can monitor whether each element or component operates properly or whether each element or component operates according to a previous instruction to perform a function.

The communication F_COM function with the OS controller means that the function controller 550 provides data obtained in F_DATA_COL, F_ELE_MONITORING, etc. to the OS controller 200.

The OS controller monitoring F_OS_MONITORING function refers to a function in which the function controller 550 transmits a predetermined packet to the OS controller 200 to check whether the OS controller 200 is operating properly.

The F_COM and F_OS_MONITORING functions can be implemented as one function. That is, even when the cooking function is not performed, the function controller 550 transmits the data obtained through the F_ELE_MONITORING to the OS controller 200. The function controller 550 can check whether the OS controller 200 is in a normal state or an abnormal state based on whether the OS controller 200 has transmitted an acknowledgement (ACK) response to the transmitted data. The normal state can refer to an error free operating state, and the abnormal state can refer to an operating state that includes one or more errors or problems.

The functions performed by the OS controller 200 include a human-interface HUMAN_IF. In addition, the functions performed by the OS controller 200 include function controller control and monitoring COOK_CONT_MON. In addition, the functions performed by the OS controller 200 include O_element monitoring O_ELE_MONITORING. In this regard, one embodiment of the function controller control and monitoring COOK_CONT_MON is that the OS controller 200 transmits a predetermined signal to the function controller 550 so that the function controller 550 can control the functional unit 500, that is, the body 1010.

The human-interface HUMAN_IF function refers to a function in which the OS controller 200 outputs a user interface, such as various information or a menu for controlling the cooking appliance, and receives a user's touch input or user command thereto.

One embodiment of the function controller control and monitoring COOK_CONT_MON is that the OS controller 200 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information for monitoring the state or an operation status of the functional unit 500, that is, the body 110, is transmitted to the OS controller 200 in a form of a predetermined wired or wireless signal.

More specifically, when the user selects a specific cooking function in the human-interface HUMAN_IF function, the OS controller 200 can instruct the function controller 550 to execute the cooking function. In addition, the OS controller 200 can perform monitoring to receive values of the operation states or cooking results of the elements or the components constituting the functional unit 500 from the function controller 550. All of these functions are included in the function controller control and monitoring COOK_CONT_MON. Accordingly, the function controller control and monitoring COOK_CONT_MON of the OS controller 200 is related to five functions of the function controller 550.

The O_element monitoring O_ELE_MONITORING refers to a function in which the OS controller 200 monitors the elements or the components of the digital controller door 100. The OS controller 200 can monitor whether each of the elements or the components operates properly, or whether each element or component operates according to a previous instruction to perform a function.

As shown in FIG. 3, the function controller 550 and the OS controller 200 perform respective given functions independently but in association with each other. Accordingly, the function controller 550 checks whether the OS controller 200 operates normally or not in the process of performing the function, while the OS controller 200 checks whether the function controller 550 operates normally or not in the process of performing the function. When an abnormality or error occurs in a component of one of the function controller 550 and the OS controller 200, the other of the function controller 550 and the OS controller 200 can cope with this situation or address the abnormality or error.

FIG. 4 is a diagram showing a process for coping with or handling an error that occurs while the function controller and the OS controller cooperate with each other according to one embodiment of the present disclosure.

The function controller 550 controls the functional unit (e.g., function unit) 500 that provides the cooking function. The OS (Operating System) controller 200 instructs the operation of the functional unit 500 and controls the digital controller door 100 that provides the human interface.

When packets are normally transmitted and received between the function controller and the OS controller, the function controller 550 and the OS controller 200 perform the function instructed according to the menu selected by the user through the digital controller door 100 in S1.

That is, the function controller 550 can perform one or more of the functions presented in FIG. 3 in S2. Similarly, the OS controller 200 can perform one or more of the functions presented in FIG. 3 in S3.

In this process, an error may occur in the transmission and reception of the packets (such as a monitoring packet, a response packet, or a packet containing an instruction message) transmitted and received between the function controller 550 and the OS controller 200 in S5. That is, when a communication packet is not transmitted therebetween or an error occurs during the reception process, the function controller 550 and the OS controller 200 check the occurrence of an error and perform an error response function accordingly.

More specifically, the function controller 550 can perform an error response function when the monitoring packet is not received by the function controller in S6. In this process, the function controller 550 can restrict the function of the functional unit 500 or cancel the function thereof in operation. Moreover, the function controller 550 can reset the OS controller 200.

The OS controller 200 can perform an error response function when a response packet is not received thereby in S7. In this process, the OS controller 200 can restrict the function of the digital controller door 100 or cancel the function thereof in operation. Moreover, the OS controller 200 can reset the communication channel over which the OS controller performs communication with the function controller 550 or output the error status as a message on the display 160.

Afterwards, in response to packets being normally transmitted and received again between the function controller 550 and the OS controller 200, the function controller 550 and the OS controller 200 can transmit an error-related record to each other at S8 and S9.

That is, each of the function controller 550 and the OS controller 200 can store, in an internal memory thereof, a record during the period during which the communication packets are not transmitted and received therebetween. Then, when the communication packets start to be transmitted and received therebetween, the function controller 550 and the OS controller 200 transmit the records respectively stored in their internal memories to each other to notify that the error has occurred.

According to one embodiment of the present disclosure, the function controller 550 can record information about a time duration during which communication with the OS controller 200 was not possible, a canceled function, a time point of cancellation, the number of times the function controller reset the OS controller 200, etc., and then transmit the recorded information to the OS controller 200 at S8.

According to one embodiment of the present disclosure, the OS controller 200 can provide the function controller 550 with information about a time duration for which the OS controller was not able to communicate with the function controller 550, information about the cooking course (menu) instructed by the user, etc.

Moreover, the OS controller 200 can transmit the record obtained in the S8 and S9 process to an external server. Alternatively, the OS controller 200 can transmit the record obtained in the S8 and S9 process to a portable device (e.g., a user device, such as a smart phone, etc.) linked to the cooking appliance.

Steps S6 and S8 are functions included in the OS controller monitoring F_OS_MONITORING of the function controller 550. Steps S7 and S9 are functions included in the function controller control and monitoring COOK_CONT_MON of the OS controller 200.

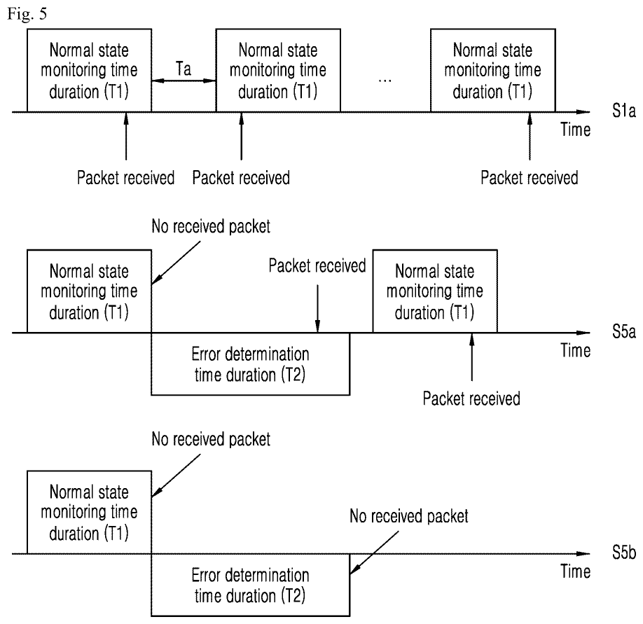

FIG. 5 shows differentiated timing diagrams when the OS controller or the function controller performs monitoring according to one embodiment of the present disclosure.

The OS controller 200 or the function controller 550 checks whether a packet is normally received during a normal state monitoring time duration T1.

In response to that a packet is normally received during the T1, as in Sla of FIG. 5, the OS controller 200 or the function controller 550 repeatedly checks the packet reception during the normal state monitoring time duration T1, periodically or according to a preset schedule.

On the other hand, in response there being no packet reception during the normal state monitoring time duration T1, as in S5a of FIG. 5, the OS controller 200 or the function controller 550 checks packet reception again or performs a task of re-transmitting a packet which the OS controller 200 or the function controller 550 has previously transmitted, during an error determination time duration T2. In addition, the OS controller 200 or the function controller 550 can reset the communication channel during this process.

In response to a packet being received during the error determination time duration T2, the OS controller 200 or the function controller 550 performs the process of S8 and S9 described above (e.g., exchange error log reports). Thereafter, the OS controller 200 or the function controller 550 repeatedly checks packet reception during the normal state monitoring time duration T1 periodically or according to a preset schedule.

Otherwise, in response there being no packet reception during the error determination time duration T2 as in S5b of FIG. 5, the OS controller 200 or the function controller 550 can perform a preset error-solving function. The OS controller 200 can display a message on the display 160 indicating that the functional unit cannot be operated. The function controller 550 can cancel the cooking function if the food is being cooked.

The preset error-solving function can be performed during the error determination time duration T2 or can be performed after the error determination time duration T2 has elapsed. In addition, in response to there being multiple preset error-solving functions, some thereof can be performed during the error determination time duration T2 and the others thereof can be performed after the error determination time duration T2 has elapsed.

That is, the function controller 550 or the OS controller 200 can check the reception status of the packet during the normal state monitoring time duration T1, and then, in response to the packet not being received during the normal state monitoring time duration T1, the function controller 550 or the OS controller 200 can perform a function to re-check the reception status of the packet or resolve the error during the error determination time duration T2.

In this regard, each of the normal state monitoring time duration T1 and the error determination time duration T2 can be fixed or variable. For example, the function controller 550 or the OS controller 200 can increase or decrease each of the normal state monitoring time duration T1 and the error determination time duration T2 based on the function that is currently in progress, the past error occurrence history, or the age of the cooking appliance (or the time duration for which it has been in operation).

In addition, an interval Ta between the normal state monitoring time durations T1 can also be increased or decreased. For example, the function controller 550 or the OS controller 200 can increase or decrease the interval Ta between the normal state monitoring time durations T1 based on the function currently in progress, the past error occurrence history, or an age of the cooking appliance (or the time duration for which it has been in operation), etc.

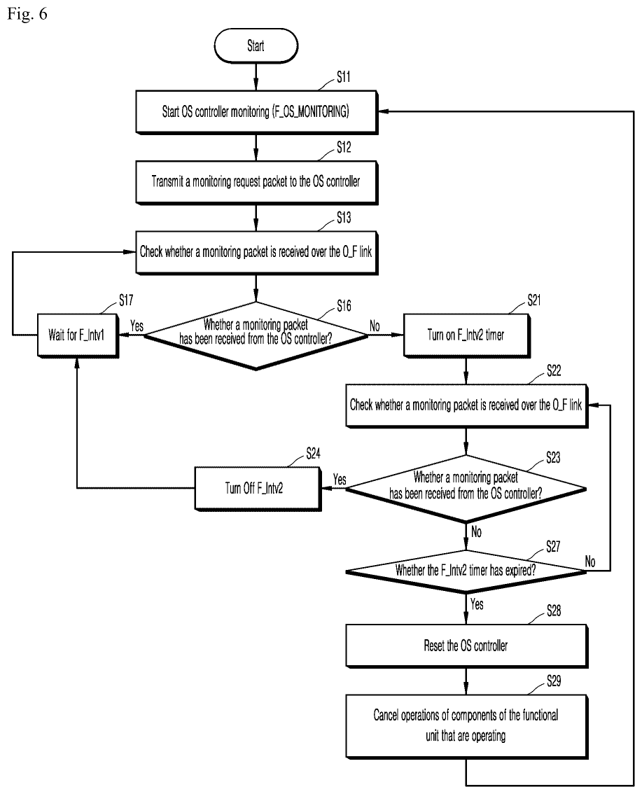

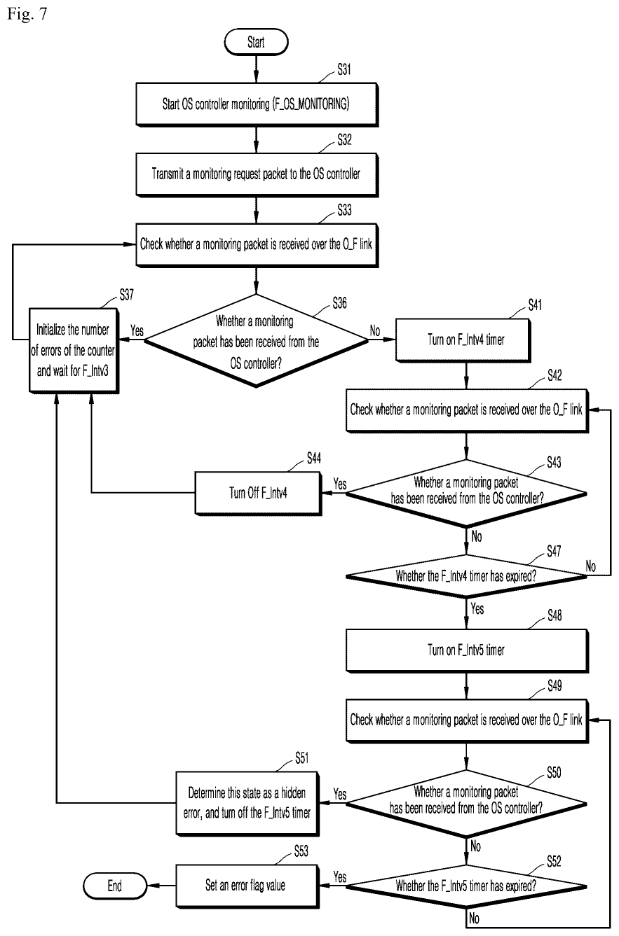

Hereinafter, the operation of the function controller 550 according to one embodiment of the present disclosure when the function controller 550 does not receive a monitoring packet from the OS controller 200 during the normal state monitoring time duration will be examined. The function controller 550 performs a task of checking whether a monitoring packet has been received from the OS controller 200 during the error determination time duration. This can refer to FIG. 6 and FIG. 7.

FIG. 6 is a diagram showing an error response process when a function controller (e.g., in the body of the cooking appliance) monitors an OS controller (e.g., in the door) and an error occurs based on the monitoring result according to an embodiment of the present disclosure (e.g., a situation where the cooking appliance (body) monitors the smart door while food is being cooked).

According to one embodiment of the present disclosure, when the function controller 550 does not receive a monitoring packet from the OS controller 200 during the normal state monitoring time duration, the function controller 550 performs a task of checking whether a monitoring packet has been received from the OS controller 200 during the error determination time duration.

The function starts the OS controller monitoring F_OS_MONITORING in S11. The function controller 550 can perform the OS controller monitoring F_OS_MONITORING while performing other functions F_COOK, F_DATA_COL, F_ELE_MONITORING, and F_COM of the function controller 550, as shown in FIG. 3. Alternatively, the function controller 550 can perform the OS controller monitoring F_OS_MONITORING alone while other functions are not executing.

The function controller 550 transmits a monitoring request packet to the OS controller 200 in S12. Then, the function controller 550 checks whether a monitoring packet is received from the OS controller 200 over the O_F link (downlink) over which data is transmitted or the control is instructed, during the normal state monitoring time duration T1 in S13. The monitoring packet can include the control packet transmitted by the OS controller 200. In other words, the monitoring packet does not refer to a specific packet alone, but includes packets transmitted by the OS controller 200 for monitoring, packets transmitted for control, etc.

In response to the function controller 550 receiving the monitoring packet from the OS controller 200 (S16—Yes), the function controller 550 determines that the OS controller 200 is in normal operation. Thus, the function controller 550 waits for a preset monitoring interval F_Intv1 in S17 and then proceeds to S13 again. Alternatively, the function controller 550 can proceed to operation S12. This corresponds to a situation where the function controller 550 transmits the monitoring request packet every time.

The F_Intv1 as the monitoring time interval in OS controller monitoring F_OS_MONITORING (corresponding to Ta in the embodiment in FIG. 5) refers to a time interval for which the OS controller 200 transmits the monitoring packet to the function controller 550. This time interval is a time duration that has been pre-arranged between the function controller 550 and the OS controller 200. According to one embodiment of the present disclosure, the F_Intv1 can be preset and fixed.

Alternatively, according to another embodiment of the present disclosure, F_Intv1 can be increased or decreased (e.g., the F_Intv1 can be variably set or adjusted).

For example, when the function controller 550 needs to perform monitoring of the OS controller 200 at a short time interval, the function controller 550 and the OS controller 200 can decrease F_Intv1.

Moreover, the function controller 550 can increase or decrease F_Intv1 depending on the cooking function or specific function performed by the function controller 550. When F_Intv1 is increased or decreased, the function controller 550 and the OS controller 200 can share an increased or decreased value of the F_Intv1 with each other.

On the other hand, in response to the function controller 550 failing to receive the monitoring packet from the OS controller 200 (S16—No), the function controller 550 enters the error determination time duration T2.

The function controller 550 turns on a timer corresponding to the F_Intv2 time duration (corresponding to the embodiment of T2 in FIG. 5) in S21. In this way, the F_Intv2 timer is turned on. Then, in response to the monitoring packet not yet being received from the OS controller 200, after the F_Intv2 time duration has elapsed, the function controller 550 can perform tasks S28 and S29 to resolve the error of the OS controller 200. For example, if the function controller 550 does not receive a monitoring packet from the OS controller 200 during a normal state monitoring time, then the function controller 500 can wait for a predetermined amount of time, before attempting one or more tasks to resolve the error in the OS controller (e.g., resetting the communication channel, restarting the OS controller, etc.).

After S21, the function controller 550 checks whether the monitoring packet has been received from the OS controller 200 over the O_F link (downlink) over which data is transmitted or the control is instructed in S22. In response to the function controller 550 receiving the monitoring packet from the OS controller 200 before the F_Intv2 timer has expired (S23—Yes), the function controller 550 determines that the OS controller 200 is in a normal operating state, and thus the function controller 550 turns off the F_Intv2 timer in S24 and proceeds to S17.

On the other hand, in response to the function controller 550 not receiving the monitoring packet from the OS controller 200 (S23—No), the function controller 550 checks whether the F_Intv2 timer has expired in S27. In response to the F_Intv2 timer not having expired yet (S27—No), the function controller 550 proceeds to operation S22 to continue checking whether the monitoring packet has been received from the OS controller 200 until the F_Intv2 timer expires.

In response to the F_Intv2 timer expired while no monitoring packet has been received (S27—Yes), the function controller 550 determines that the OS controller 200 is not in a normal operating state. Thus, the function controller 550 resets the OS controller 200 in S28 and cancels the operations of the components 560, 570, 580, and 590 of the functional unit 500 that are operating in S29. For example, when the function controller 550 does not receive a monitoring packet from the OS controller 200 during a normal state monitoring time, then the function controller 500 can wait for a predetermined amount of time while still checking for monitoring packets, and if no monitoring packets are received after the predetermined amount of time has elapsed, then the function controller 550 can reset of the OS controller 200 and turn off its own functions (e.g., cancel cooking or heating, etc.) in order to improve safety.

The embodiment of FIG. 6 can be applied to an embodiment in which the cooking appliance 1000 is a microwave oven, the function controller 550 is a microcomputer that controls the microwave oven, and the OS controller 200 is an Android OS (e.g., an Android board).

In this regard, the OS controller 200 can be implemented to transmit a monitoring packet to the function controller 550 or to transmit an ACK packet (response packet), etc. at a predefined time interval. In response to the function controller 550 not receiving a monitoring packet from the OS controller 200 for 60 seconds (F_Intv2) or fails to communicate with the OS controller 200, the function controller 550 can reset the OS controller 200 (e.g., the Android board), and cancel the cooking operation currently being performed by the microwave oven.

In the cancellation process, the function controller 550 can cancel the operations of the components (elements) of the functional unit 500, such as the cooking appliance function provider 560, the inside lamp 570 as an example of an oven lamp, the outside lamp 580 as an example of a cooktop lamp, and the ventilation fan 590. In this process, when the ventilation fan 590 is performing an auto ventilation operation, the function controller 550 may not cancel the operation of the ventilation fan 590. For example, continuing to operate the ventilation fan while an error is present can improve safety, especially if an error occurs in the smart door due to overheating or moisture, etc.

The function controller 550 embodied as a microcomputer can reset the Android board as the OS controller 200, in response to the function controller not receiving a signal from the OS controller 200 for a preset period of time, such as 60 seconds or 30 seconds. This is a function performed only in an emergency situation. In addition, the function controller 550 cannot reset or is not allowed the authority to reset the OS controller 200 in a normal operation situation.

That is, in response to the function controller 550 not receiving a monitoring packet from the OS controller 200 during the error determination time duration, the function controller 550 can reset the OS controller 200 in S28 and store a record of the OS controller reset in the internal memory of the function controller 550.

Furthermore, in response to the function controller 550 not receiving a monitoring packet from the OS controller 200 during the error determination time duration, the function controller 550 can cancel the operation of each of the components (e.g., elements) of the functional unit 500 and store a record of the operation cancellation in the internal memory of the function controller 550.

That is, in the S29 process, the function controller 550 can cancel the operations of all components (elements) of the functional unit 500 (e.g., shut itself down and turn off cooking). Alternatively, the function controller 550 can cancel the operations of some of the components (elements) of the functional unit 500 (e.g., turn off cooking, while allowing the ventilation fan to continue running).

For example, in response to the ventilation fan 590 among the components (elements) of the functional unit 500 performing the auto ventilation function, the function controller 550 can maintain the operation of the ventilation fan 590 for a preset time duration. For example, in response to the thermistor 595 detecting external heat, the auto ventilation function can be performed and maintained. In this situation, the function controller 550 can maintain the operation of the ventilation fan 590. In this regard, the function controller 550 can continuously check the heat detected by the thermistor 595, and then can control the operation of the ventilation fan 590 based on the checking result (e.g., independent from checking for a monitoring packet).

In addition, in response to the inside lamp 570 and/or the outside lamp 580 among the components (elements) of the functional unit 500 being turned on, which are necessary for the user to recognize the cooking appliance 1000, the function controller 550 can maintain the inside lamp 570 and/or the outside lamp 580 in the turned on state for a preset time duration, such as 1 minute or 3 minutes (e.g., this can improve user safety and convenience, even while the smart door may be experiencing an error situation).

In response to the function performed by the cooking appliance function provider 560 of the functional unit 500 being terminated within a preset time duration, for example, 5 seconds or 3 seconds, the function controller 550 can terminate the operation of the cooking appliance function provider 560 after the cooking appliance function provider 560 has finished the operation.

In this process, in response to the thermistor 595 detecting the internal heat and determining that the detected heat is at a high temperature higher than a predefined reference temperature, the function controller 550 can immediately terminate the operation of the cooking appliance function provider 560.

In summary, in the process S29, when the function controller 550 cancels the operation of each of the components (elements) of the functional unit 500 that are in operation, the function controller 550 can selectively cancel or maintain the operation of each of the components of the functional unit 500 based on the operation status of each element/component or the external environment.

The embodiment of FIG. 6 can be applied to both a situation where the cooking appliance performs a specific cooking function and a situation where the cooking appliance does not perform the specific cooking function.

In the situation where the cooking appliance does not perform the operation such as heating or cooking, the embodiment of FIG. 6 can be applied. In this regard, the monitoring on the OS controller can be performed as in FIG. 7.

FIG. 7 is a diagram showing an error response process when a function controller monitors an OS controller and an error occurs based on the monitoring result according to another embodiment of the present disclosure (e.g., a situation where the cooking appliance (body) monitors the smart door while food is not being cooked). When the cooking appliance does not perform cooking or the elements, e.g., the components of the functional unit 500 do not operate, the function controller 550 does not need to immediately check the operating status of the OS controller 200. Therefore, the function controller 550 can perform the OS controller monitoring F_OS_MONITORING in a different manner than the manner in FIG. 6. For example, the process in FIG. 6 can be referred to as a cooking on type of situation (e.g., active mode, or cooking mode), and the process in FIG. 7 can be referred to as a cooking off type of situation (e.g., standby mode, or display only mode), but embodiments are not limited thereto.

The function controller 550 starts the OS controller monitoring F_OS_MONITORING S31. At this time, the components or the elements of the functional unit 500 are not performing separate operations (e.g., a standby mode or a situation where food is not being cooked). In addition, the function controller 550 may not perform other functions F_COOK, F_DATA_COL, F_ELE_MONITORING, and F_COM of the function controller 550 as presented in FIG. 3. Alternatively, the function controller 550 can perform the F_element monitoring F_ELE_MONITORING. Alternatively, the function controller 550 can perform only the OS controller monitoring F_OS_MONITORING.

The function controller 550 transmits a monitoring request packet to the OS controller 200 in S32. Then, the function controller 550 checks whether a monitoring packet is received from the OS controller 200 over the O_F link (downlink) over which data is transmitted or the control is instructed during the normal state monitoring time duration T1 in S33.

In response to the function controller 550 receiving a monitoring packet from the OS controller 200 (S36—Yes), the function controller 550 determines that the OS controller 200 is in a normal operation state Thus, the function controller 550 waits for a preset monitoring interval F_Intv3 in S37 and then proceeds to S33. In this regard, in response to that the number of error occurrences was counted before S32, it is determined that the monitoring packet is normally received at S36. Thus, the function controller 550 can perform the task of initializing the number of errors of the counter at S37 (e.g., setting the current error count to zero).

In this regard, the F_Intv3 as the monitoring time interval in the OS controller monitoring F_OS_MONITORING refers to a time interval for which the OS controller 200 transmits the monitoring packet to the function controller 550. This time interval is a time duration as pre-arranged upon between the function controller 550 and the OS controller 200. According to one embodiment of the present disclosure, this time duration can be preset and fixed.

Alternatively, according to another embodiment of the present disclosure, this time duration can be increased or decreased (e.g., the F_Intv3 can be variably set or adjusted).

For example, when the function controller 550 needs to perform monitoring on the OS controller 200 at a long time interval, the function controller 550 and the OS controller 200 can increase the F_Intv3.

Moreover, in response to that the function controller 550 does not perform the cooking, etc. for a long time duration, the F_Intv3 can be increased (e.g., during an idle mode or standby mode). In response to the F_Intv3 being increased or decreased, the function controller 550 and the OS controller 200 can share the increased or decreased value of the F_Intv3 with each other.

On the other hand, in response to the function controller 550 not receiving a monitoring packet from the OS controller 200 (S36—No), the function controller 550 turns on the timer corresponding to the F_Intv4 time duration in S41. That is, the function controller 550 enters the error determination time duration T2. In this way, the F_Intv4 timer is turned on. In response to the monitoring packet still not yet being received from the OS controller 200, after the F_Intv4 time duration, for example, 30 seconds, has elapsed, the function controller 550 can perform a task to respond to the error of the OS controller 200.

After S41, the function controller 550 checks whether a monitoring packet is received from the OS controller 200 over the O_F link (downlink) over which data is transmitted or the control is instructed in S42. In response to the function controller 550 receiving a monitoring packet from the OS controller 200 (S43—Yes), the function controller determines that the OS controller 200 is in a normal operating state. Thus, the function controller 550 turns off the F_Intv4 timer in S44 and then proceeds to S37. At this time, the function controller 550 terminates the error determination time duration T2.

On the other hand, in response to the function controller 550 not receiving a monitoring packet from the OS controller 200 (S43—No), the function controller 550 checks whether the F_Intv4 timer has expired in S47. In response to that the F_Intv4 timer not being expired yet (S47—No), the function controller 550 proceeds to operation S42 in which the function controller is configured to continue check whether a monitoring packet has been received from the OS controller 200 until the F_Intv4 timer has expired.

In response to F_Intv4 timer having expired without any monitoring packet being received (S47—Yes), it is determined that the OS controller 200 is not in a normal operation. Thus, the function controller 550 turns on a F_Intv5 timer in S48. The F_Intv5 (for example, 3 hours) timer is a timer set for coping with the error. The F_Intv5 is a longer time duration than the F_Intv4.

Upon turning on the F_Intv5 timer, the function controller 550 checks whether a monitoring packet is received over the O_F link (downlink) in S49. In response to the function controller 550 receiving a monitoring packet from the OS controller 200 (S50—Yes), the function controller 550 determines this state as a hidden error, and turns off the F_Intv5 timer in S51 and then proceeds to S37. At this time, function controller 550 ends the error determination time duration T2.

On the other hand, in response to the function controller 550 not receiving a monitoring packet from the OS controller 200 (S50—No), the function controller 550 checks whether the F_Intv5 timer has expired in S52. In response to the F_Intv5 timer not being expired yet (S52—No), the function controller 550 proceeds to operation S49 in which the function controller 550 continues to check whether a monitoring packet has been transmitted from the OS controller 200 until the F_Intv5 timer has expired.

In response to the F_Intv5 timer having expired without receiving any monitoring packet form the OS controller 200 (S52—Yes), the function controller 550 determines that the OS controller 200 is not operating normally. Thus, the function controller 550 sets an error flag value in the internal memory or a storage space or a flag in S53.

This is a situation where the OS controller 200 is not operating normally. Thus, when the OS controller 200 is reset or restarted later, the OS controller 200 checks this error flag value so that it can check whether an error has occurred. In this regard, at operation S53, the function controller 550 ends the error determination time duration T2 as described in S5b of FIG. 5. However, the timing does not enter the normal state monitoring time duration T1.

The embodiment of FIG. 7 can be applied to an embodiment in which the cooking appliance 1000 is a microwave oven, the function controller 550 is a microcomputer that controls the microwave oven, and the OS controller 200 is an Android OS (e.g., Android board).

Each of the intervals of FIG. 6 and FIG. 7 can be adjusted based on the operation status or function status of the functional unit 500. This will be described later.

Next, a process in which the OS controller 200 monitors the function controller 550 will be described.

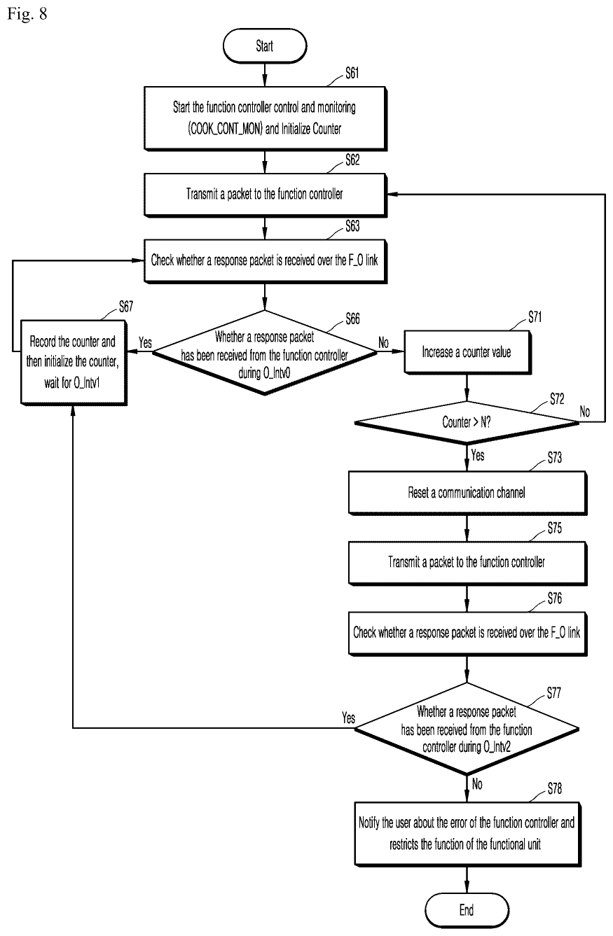

FIG. 8 is a diagram showing an error response process when an OS controller monitors a function controller and an error occurs based on the monitoring result according to an embodiment of the present disclosure (e.g., a situation where the smart door monitors the status of the cooking appliance).

A process S62, S63, S66, and S67 correspond to the normal state monitoring time duration T1 as identified in FIG. 5. A process S71 to S78 correspond to the error determination time duration T2 as identified in FIG. 5.

The OS controller 200 transmits a monitoring packet to the function controller 200. Thereafter, in response to the OS controller 200 not receiving a response packet from the function controller 550 during the normal state monitoring time duration, the OS controller 200 can check whether a response packet has been received from the function controller 550 during the error determination time duration, and determine whether there is an error based on the checking result, and take a follow-up action accordingly.

The OS controller 200 starts the function controller control and monitoring COOK_CONT_MON in S61. In S61, the OS controller 200 initializes a counter. Then, the number of packet reception errors is counted, and the OS controller 200 responds to a situation in which the number of the errors exceeds a predefined value. For example, the counter initialization means setting the counter to 0.

The OS controller 200 can perform the function controller control and monitoring COOK_CONT_MON while performing the human-interface HUMAN_IF or the O_element monitoring O_ELE_MONITORING as presented in FIG. 3.

Moreover, the OS controller 200 can start the function controller control and monitoring COOK_CONT_MON according to its own schedule or upon determination that it is required, or can start the function controller control and monitoring COOK_CONT_MON according to the request of the function controller 550 as identified in FIG. 6 or FIG. 7.

The OS controller 200 transmits a packet to the function controller 550 in S62. The packet can include an indication that instructs the function controller 550 to perform a predefined function or to transmit a predefined response from the function controller 550 thereto. The packet of S62 can be transmitted through the O_F link (e.g., downlink), and the OS controller 200 checks whether the packet (response packet) has been received over the F_O link in S63.

In this regard, the packet can be a packet transmitted for monitoring or controlling and can correspond to the monitoring packet of FIG. 6 or FIG. 7. Alternatively, the packet can be a differentiated packet from the monitoring packet of FIG. 6 or FIG. 7.

When a response packet is received from the function controller 550 based on a result of checking whether the packet is received during the time duration of O_Intv0 (S66—Yes), it is determined that the function controller 550 is in a normal operating state. Thus, the OS controller 200 waits for a preset monitoring interval O_Intv1 (an example of Ta in FIG. 5) in S67 and then proceeds to operation S62 again. In the S67 process, in response to the counter value being 1 or greater, the OS controller 200 can determine that an error occurs in the reception of the response packet and records the error occurrence and then initializes the counter.

In this regard, the O_Intv0 can be included in one embodiment of the normal state monitoring, and can be counted after the packet transmission of S62, and the O_Intv0 can be preset. Alternatively, the OS controller 200 can reset or increase or decrease the O_Intv0 depending on the operating state of the cooking appliance 1000 or the function being performed. One example of the O_Intv0 is 300 ms. However, the present disclosure is not limited thereto.

In one embodiment, the O_Intv0 can be 300 ms. In this situation, the OS controller 200 can check whether a response packet is received over the F_O link for 300 ms after the packet transmission of S62. In response to a response packet not being received for a time duration longer than the O_Intv0, the OS controller 200 can proceed to operation S71.

The O_Intv1 as the monitoring time interval in the function controller controlling and monitoring COOK_CONT_MON can be included in one embodiment of the normal state monitoring, and refers to a time interval during which the OS controller 200 transmits a packet to monitor the function controller 550. This time interval can be a time duration pre-agreed upon between the function controller 550 and the OS controller 200. According to one embodiment of the present disclosure, this time duration can be preset and fixed.

In this regard, the O_Intv1 and the F_Intv1 of FIG. 6 and the F_Intv3 of FIG. 7 can be set to be identical with each other or be different from each other.

According to one embodiment of the present disclosure, the O_Intv1 can be preset and fixed.

Alternatively, according to another embodiment of the present disclosure, the O_Intv1 can be increased or decreased (e.g., variably set or dynamically adjustable).

For example, in a situation where it is necessary for the OS controller 200 to perform monitoring of the function controller 550 at a short time interval, each of the OS controller 200 and the function controller 550 can decrease the O_Intv1.

Furthermore, when the function controller 550 does not perform the cooking, etc. for a long time duration, the O_Intv1 can be increased.

That is, the OS controller 200 can increase or decrease the O_Intv1 depending on the cooking function or specific function performed by the function controller 550. In response to the O_Intv1 being increased or decreased, the OS controller 200 and the function controller 550 can share the increased or decreased value of the O_Intv1 with each other.

When the OS controller 200 does not receive a response packet from the function controller 550 for the O_Intv0 (S66—No), this means that the response to the packet transmitted over the downlink O_F link has not been received for the O_Intv0, for example, 300 ms.

Therefore, the OS controller 200 requests re-transmission of the response packet to the function controller 550 a total of N times (e.g., 3 times). As discussed above, the number of re-transmissions can also increase or decrease depending on the cooking status of the functional unit 500, a remaining cooking time duration, the past error occurrence situation, etc. The number of re-transmissions is included in one embodiment of the error determination time duration.

The OS controller 200 increases the counter in S71 and checks whether the counter value exceeds a specific number of times N in S72. When the counter value does not exceed the specific number of times N, the OS controller 200 re-transmits the packet to the function controller 550 in S62. While the OS controller 200 repeats the S62 to S72 process, the OS controller 200 can check whether a response packet has been received from the function controller 550.

When a response packet has not been received from the function controller 550 after the re-transmission N times or greater, that is, in response to the counter value in S72 exceeding N (e.g., 3), the OS controller 200 determines that there is a communication error therebetween and resets the communication channel in S73.

For example, when the communication protocol is UART, the OS controller 200 resets (initializes) the UART port. The reset scheme includes a scheme of closing/opening the UART port. As a result, the OS controller 200 resumes communication with the function controller 550.

In this regard, a time duration for which the number of re-transmissions reaches the specific number of times N can be included in one embodiment of the error determination time duration. The OS controller 200 can reset the communication channel for transmitting and receiving packets with the function controller 550 when no response packet is received from the function controller 550 during the error determination time duration.

Thereafter, the OS controller 200 transmits the packet to the function controller 550 again in S75. Then, the OS controller is configured to check the packet reception during the time duration (e.g., 30 seconds or 40 seconds) of O_Intv2 in S76 and S77. In response to a response packet being from the function controller 550 (S77—Yes), the OS controller 200 determines that the function controller 550 is in a normal operating state. Thus, the OS controller 200 records and initializes the counter as the number of error occurrences, and then, waits for the preset monitoring interval O_Intv1 in S67 and then proceeds to S62 again.

In this regard, instead of waiting for the reception of the response packet during the time duration of the O_Intv2, the OS controller 200 can perform packet re-transmission K times and check the reception of the response packet accordingly. This can be implemented in various ways.

On the other hand, when no packet is received during the time duration (e.g., 30 seconds or 40 seconds) of the O_Intv2, the OS controller 200 notifies the user about the error of the function controller 550 and restricts the function of the functional unit 500 in S78. In this process, the OS controller 200 can record the number of error occurrences, etc.

That is, when the OS controller 200 does not receive a response packet from the function controller 550 during the O_Intv2 as included in one embodiment of the error determination time duration, the OS controller 200 can display a message indicating that the cooking appliance 1000 cannot perform cooking on the display 160 of the digital controller door 100 and store error occurrence information in the internal memory thereof.

For example, the OS controller 200 can display an ongoing notification on the display 160 to notify the user that the cooking function of the cooking appliance cannot be used. Then, the OS controller 200 cancels any cooking currently in progress if any. Then, the OS controller 200 only performs a function (such as the human interface, the O_element monitoring, etc. of FIG. 3) that is not performed by the functional unit 500, other than the cooking function of the cooking appliance. In this way, the user can be prevented from cooking food until the problem with the smart door has been resolved. For example, if the user is still allowed to cook food while the smart door is faulty, this can lead to dangerous situations, such as the user attempting to cancel cooking via the smart door but the cooking may continue uncontrollably.

Afterwards, when the error has been solved via device inspection, etc., the OS controller 200 can remove the ongoing notification displayed on the display 160 and display an interface that allows the cooking function to be used on the display 160.

The embodiment of FIG. 8 can be applied to an embodiment in which the cooking appliance 1000 is a microwave oven, the function controller 550 is a microcomputer that controls the microwave oven, and the OS controller 200 is an Android OS (e.g., Android board).

In this situation, when a communication error from the microcomputer to the Android board occurs, the Android OS can respond to the error as follows. As examined in S73, the OS controller 200 (e.g., the Android OS) performs UART port close/open.

That is, in response to the Android OS not receiving a response to the TX (downlink) from the microcomputer within 300 ms, the Android OS requests the microcomputer to re-transmit a total of N times (e.g., 3 times). In response to the Android OS not receiving a response to the N (3) times of re-transmissions, the Android OS determines that there is a communication error and performs UART port reset (close/open) to resume communication with the microcomputer.

Meanwhile, when communication is not possible for 30 to 40 seconds even though the communication channel reset operation has been executed, the OS controller 200 (e.g., the Android OS) displays an error message on the screen and cancels the cooking in progress. The process in which the error message is displayed as an ongoing notification and the notification is removed when the error has been solved is the same as discussed above. In this regard, the notification can be prevented from being arbitrarily removed by the user, so that the selection of the cooking function or the operation for cooking of the cooking appliance can be blocked.

This corresponds to the situation where the OS controller 200 (e.g., the Android OS) requests re-transmission when it does not receive a response from the function controller 550 (e.g., the microcomputer). When the response is not received continuously, the OS controller 200 can reset the port and resume communication. However, when the communication is not possible for a predefined time duration (e.g., 30 to 40 seconds) even though the above reset operation has been executed, the OS controller 200 displays an error message, cancels cooking, and displays a notification so that the user can check the situation.

In response to an error occurring in the microcomputer as an example of the function controller 550, the OS controller 200 can only use functions unrelated to the microcomputer. In response to the user selecting a specific function of the microwave oven, the OS controller 200 indicates that the microcomputer has a failure.

The timer or various time intervals used in FIGS. 6 to 8 can be implemented as a counter. Conversely, the counter used in FIGS. 6 to 8 can also be implemented as the time interval.

That is, the OS controller 200 and the function controller 550 can use a scheme of counting the error occurrences or checking the elapsed time duration in terms of a temporal criterion used for one of the OS controller 200 and the function controller 550 to check whether the other of the OS controller 200 and the function controller 550 is in an error state or a normal operating state.

Further, the temporal criteria can vary according to the function performed by each of the OS controller 200 and the function controller 550, the number of past error occurrences, or the age of the home appliance, etc.

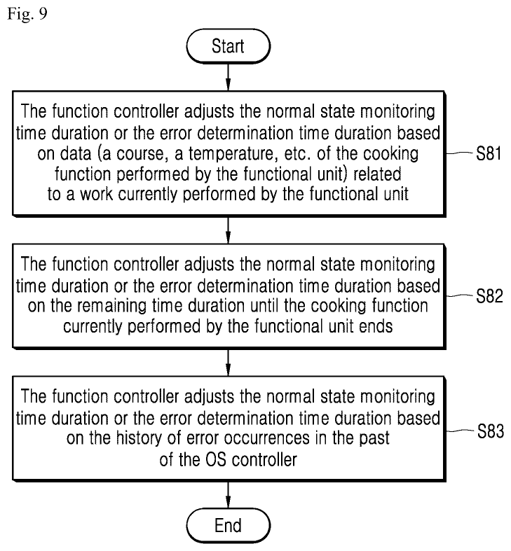

FIG. 9 is a diagram showing a process in which the function controller is configured to adjust the normal state monitoring time duration or the error determination time duration described above according to one embodiment of the present disclosure.

The function controller 550 can adjust the normal state monitoring time duration or the error determination time duration based on data (e.g., a course, a temperature, etc. of the cooking function performed by the functional unit) related to a work currently performed by the functional unit 500 in S81.

In one embodiment, when the functional unit 500 performs an operation at a temperature higher than a predefined value, the function controller 550 can adjust the normal state monitoring time duration or the error determination time duration to be shorter to improve safety. In this situation, when an error occurs in communication with the OS controller 200, the function controller 550 can immediately check the error occurrence status and cancel the operation of the functional unit 500.

In another embodiment, in response to the functional unit 500 performing a function executed at a low temperature below a predefined reference value, or in response to that the functional unit 500 is not cooking, the function controller 550 can adjust the normal state monitoring time duration or the error determination time duration to a longer time duration. In this situation, in response to an abnormality occurring in the communication with the OS controller 200, the OS controller 200 can wait to resolve the error by itself, and the function controller 550 can slowly check the error occurrence state and cancel the operation of the functional unit 500.

Moreover, the function controller 550 can adjust the normal state monitoring time duration or the error determination time duration based on the remaining time duration until the cooking function currently performed by the functional unit 500 ends in S82.

When the cooking function has ended within a preset reference time duration, e.g., in a short amount of time such as 1 second or 3 seconds, the function controller 550 can adjust the normal state monitoring time duration or the error determination time duration to a longer time duration. As a result, even when an error occurs, the function controller 550 can determine whether a communication error with the OS controller 200 occurs or resolve the communication error after the cooking function that is about to end has been terminated.

Conversely, when the remaining time duration until the end of the cooking function currently performed by the functional unit 500 is much longer (e.g., 3 minutes, 10 minutes, etc.), the normal state monitoring time duration or the error determination time duration can be set to a default setting, such that the abnormal state of the OS controller 200 can be checked during the normal determination time duration.

Next, the function controller 550 can adjust the normal state monitoring time duration or the error determination time duration based on the history of error occurrences in the past of the OS controller 200 in S83. For example, when there is no record of an error occurrence in the OS controller 200 for a predefined period of time in the past, e.g., error free for the past 3 months, the normal state monitoring time duration or the error determination time duration can be applied in a non-changed state.

On the other hand, when the number of times an error has occurred in the past is N times (e.g., 5 times) or greater, it is determined that the possibility of an error currently occurring increases. Thus, the function controller 550 can adjust the normal state monitoring time duration or the error determination time duration to a shorter time duration to quickly check a communication abnormality with the OS controller 200.

In this way, the function controller 550 can increase or decrease the normal state monitoring time duration or the error determination time duration according to a specific situation. When the situation is solved, the normal state monitoring time duration or the error determination time duration can be restored to the default value. In this way, power consumption and resources can be efficiently managed while also factoring in safety considerations.

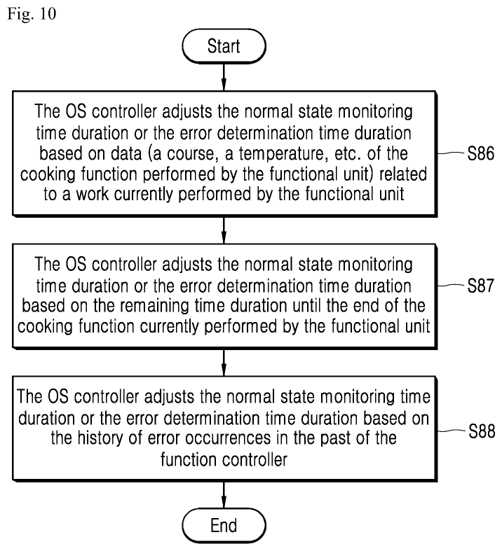

FIG. 10 is a diagram showing a process in which the OS controller is configured to adjust the above-described normal state monitoring time duration or error determination time duration according to one embodiment of the present disclosure.

The OS controller 200 can adjust the normal state monitoring time duration or the error determination time duration based on data (e.g., a course, a temperature, etc. of the cooking function performed by the functional unit) related to a work currently performed by the functional unit 500 in S86.

In one embodiment, when the functional unit (e.g., function unit) 500 performs a function at a temperature higher than a predefined reference value, the OS controller 200 can adjust the normal state monitoring time duration or the error determination time duration to be shorter for enhanced safety. In this situation, when an error occurs in communication with the function controller 550, the OS controller 200 can immediately check the error occurrence state and perform a subsequent task to restore the normal state.

In another embodiment, when the functional unit 500 performs a function at a temperature lower than a predefined reference value, or when the functional unit 500 is not cooking, the OS controller 200 can adjust the normal state monitoring time duration or the error determination time duration to be longer. In this situation, when an error occurs in communication with the function controller 550, the OS controller 200 can increase the number of times the communication channel is reset to resolve the error or can slowly check the error occurrence state.

Moreover, the OS controller 200 can adjust the normal state monitoring time duration or the error determination time duration based on the remaining time duration until the end of the cooking function currently performed by the functional unit 500 in S87.

When the current cooking function will finished within the preset time duration criteria, e.g., within a short amount of time such as 1 second or 3 seconds, the OS controller 200 can adjust the normal state monitoring time duration or the error determination time duration to a greater value. As a result, when an error occurs, the OS controller 200 can determine whether a communication error with the function controller 550 occurs or resolve the error after the cooking function that is about to end has been finished.

Conversely, when the remaining time duration until the end of the cooking function currently performed by the functional unit 500 is a relatively long amount of time, e.g., 3 minutes or 10 minutes, the normal state monitoring time duration or the error determination time duration can be set to the default setting, such that the abnormal state of the function controller 550 can be identified during the normal determination time duration.

Next, the OS controller 200 can adjust the normal state monitoring time duration or the error determination time duration based on the history of error occurrences in the past of the function controller 550 in S88. For example, when there is no record of error occurrences in the function controller 550 for a predefined period of time in the past, e.g., error free for the past 3 months, the normal state monitoring time duration or the error determination time duration can be applied in a non-changed state.

On the other hand, when the number of times an error has occurred for a predefined period of time in the past is N times (e.g., 5 times) or greater, it is determined that the possibility of another error occurring increases. Thus, the OS controller 200 can adjust the normal state monitoring time duration or the error determination time duration to a shorter time value to more quickly check for an abnormal communication status with the function controller 550.

In this way, the OS controller 200 can dynamically increase or decrease the normal state monitoring time duration or the error determination time duration according to a specific situation. When the situation has been solved, the normal state monitoring time duration or the error determination time duration can be restored to the default value.

In a situation where the OS controller 200 according to an embodiment of the present disclosure is embodied as an Android board that controls the LCD or OLED screen of the digital controller door and the touch input thereon, and the function controller 550 is embodied as a microcomputer or a main PCB that controls the operation of the microwave oven, the above embodiment can be implemented as follows.

The digital controller door 100 (e.g., smart door or display door) can control communication between the Android board and the main PCB and the operation thereof. The Android board can control the digital controller door and can also provide a user interface for controlling the cooking function (e.g., the cooking function of the microwave oven) of the cooking appliance 1000 to the display 160. That is, the user can control the function of the microwave oven using the user interface displayed on the screen of the digital controller door 100 controlled by the Android board.

That is, the Android board can process information related to the digital function provided by the digital controller door 100 (e.g., smart door). Moreover, the Android board can control the function of the microwave oven through a predetermined communication medium (such as a wired or wireless medium) with the microcomputer (main PCB) of the microwave oven and display the operation status of the microwave oven on the screen.

The Android OS controller (Android OS Control Unit) of the Android board can communicate with and control the microwave oven controller (as an example of the function controller) as a controller of the microwave oven (Microwave Oven Control Unit). The microwave oven controller (Microwave Oven Control Unit) as the controller of the microwave oven is an example of the function controller of the functional unit 500 and can provide a typical oven function.

The Android OS controller (Android OS Control Unit) of the Android board can control the screen and provide a user interface according to touch input to the screen, communicate with an external server, and provide the function of the ThinQ app. In addition, when a new function is upgraded, the Android OS controller (Android OS Control Unit) of the Android board can display a new UI/UX corresponding to the upgraded function on the screen and instruct the microwave oven controller (Microwave Oven Control Unit) to perform a predefined function operation accordingly.

In response to a communication error occurring between the microwave oven controller (Microwave Oven Control Unit) or the microcomputer and the Android board, or in response to that one thereof is turned off such that a communication error occurs, a following process can be performed to address or resolve the error.

The Android board can provide an interface that contacts the user. Thus, when communication with the microcomputer board is cut off or an abnormality occurs in the microcomputer board, the Android board displays this situation on the screen to notify the user of the situation. Since the user can check information about the microwave oven through the Android board, the Android board can continuously collect, store, and monitor various information generated during the operation of the microwave oven.

Next, an example in which the auto ventilation operation is maintained when the function controller 550 checks an abnormality in the OS controller 200 will be described.

When the thermistor 595 detects the temperature, the ventilation fan 590 can automatically operate based on the detected temperature. This is referred to as the auto ventilation. The function controller 550 can automatically activate the auto ventilation function based on the temperature sensed by the thermistor 595 to prevent component failure or damage.

That is, the function controller 550 can activate the auto-ventilation function when it is determined that the temperature of the thermistor is equal to or higher than a predetermined temperature, and accordingly, can notify the OS controller 200 of information indicating that the auto-ventilation function is being activated. In response to reception of the notification, the OS controller 200 can display an auto ventilation operation state on the display 160.

The OS controller 200 can display, on the display 160, a pop-up message indicating that the auto ventilation is being activated when the temperature sensed by the thermistor 595 reaches a predetermined temperature condition. This is a function that the user may not cancel or change arbitrarily. Accordingly, the OS controller 200 can display information indicating that the auto ventilation operation is being performed on the display 160 and can also output a message indicating that the auto ventilation operation cannot be changed or cancelled. The user may not set a timer for this auto ventilation operation. The ventilation fan 590 is terminated when the auto ventilation has been terminated even though the user turns off the cooking appliance 1000 on the display 160.

In addition, the auto-ventilation can be executed when a timer is set. In this situation, the OS controller 200 can display a remaining timer time on the display 160 when the auto-ventilation operation will be terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (strong intensity). After the cooking has been finished, the ventilation fan 590 can operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 cooperates with the OS controller 200, the operations of other components of the functional unit 500 can be canceled, but the operation of the ventilation fan 590 executing the auto ventilation can be maintained. Similarly, even when there is no instruction from the OS controller 200, the function controller 550 can automatically start or end the operation of the ventilation fan 590 based on the temperature sensed by the thermistor 595.

Hereinafter, a schematic outer appearance and configuration of a cooking appliance including the digital controller door 100 of the present disclosure will be described. This corresponds to one embodiment of the present disclosure, and a scheme and a direction in which the digital controller door 100 is opened can be implemented in various ways.

The present disclosure relates to a scheme for controlling a cooking appliance using a digital controller door (e.g., smart display door) disposed at a front surface of the cooking appliance.

According to the present disclosure, a door of a microwave oven disposed on top of an oven or a gas stove acts as an LCD screen (an embodiment of a display). The Android board (an embodiment of an OS controller) of the LCD screen and the microcomputer (an embodiment of a function controller) of the microwave oven cooperate with each other. An LCD component operates according to various operating/external environments of the microwave oven or controls a specific function of the microwave oven.

The digital controller door of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD providing various user interfaces such as a touch screen, and is capable of storing and cooking food therein.

A display can be mounted on a front surface of a digital controller door provided in the cooking appliance of the present disclosure to provide various information to a user. The user can know the cooking state of the cooked food on the display.

In addition, when the display is connected to another home appliance to serve as a hub of the home appliances, the information other than cooking food can be obtained through the display. In addition, a command necessary for cooking and various other commands can be input to the display in a touch manner.

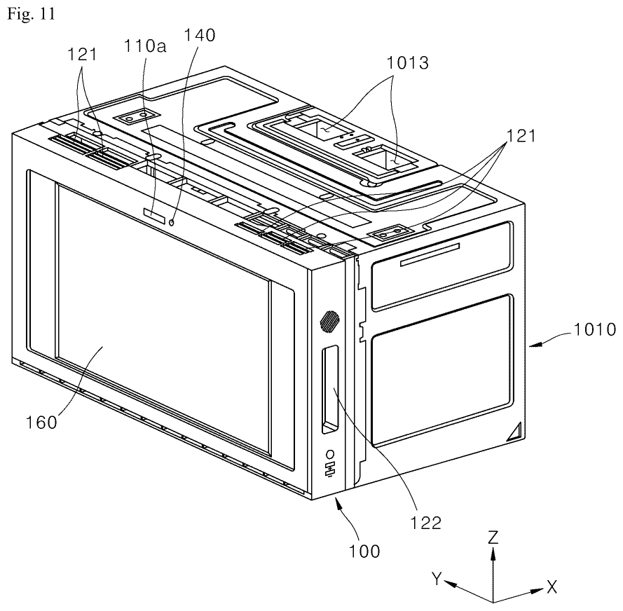

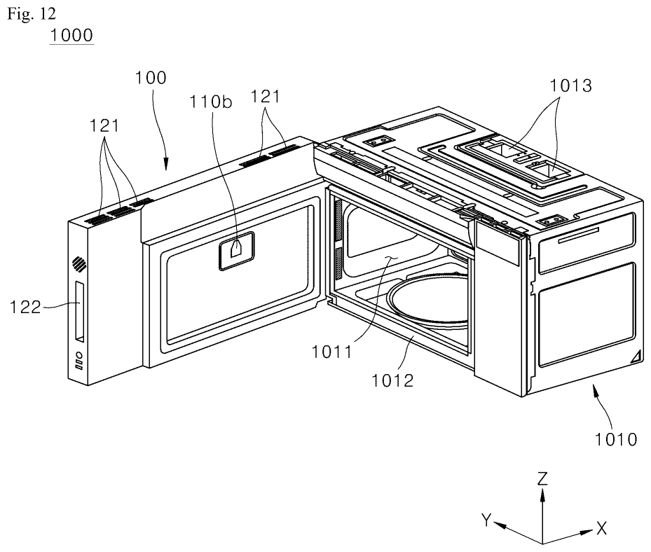

FIG. 11 is a perspective view illustrating a cooking appliance according to an embodiment of the present disclosure. FIG. 12 is a diagram illustrating a state in which the digital controller door 100 is opened in FIG. 11.

The cooking appliance according to the embodiment can be disposed at a position spaced apart from the heating cooking device in the vertical direction above a position where a heating-type oven, a gas stove, etc. are disposed.

Due to the arrangement of the cooking appliance, a user can conveniently use the heating cooking device including the cooking appliance. In addition, the cooking appliance can serve as a hood of the heating cooking device disposed under the cooking appliance. In this situation, the cooking appliance can include components for use as the hood.

The cooking appliance can cook food using microwaves belonging to electromagnetic waves and/or heater heat. The cooking appliance can include the body 1010 in which a cavity 1011 is formed, and the digital controller door 100 configured to open and close the cavity 1011. The body 1010 is an embodiment of the functional unit 500 of FIG. 2 as described above. According to an embodiment of the present disclosure, the body 1010 can act in the same manner as the functional unit 500 can. Alternatively, according to an embodiment of the present disclosure, the components of the functional unit 500 can be implemented in the body 1010. Accordingly, in various embodiments, the functional unit 500 and the body 1010 can be interchangeable with each other.

Food to be cooked can be placed in the cavity 1011. The digital controller door 100 can be disposed in front of the cavity 1011 and pivotally mounted at the body 1010 to open and close the cavity 1011.

A ventilation hole 1013 for discharging air suctioned from a suction unit provided at a lower portion of the body 1010 to the outside can be provided at an upper portion of the body 1010. A suction unit can be provided at a lower portion of the body 1010 of the cooking appliance. Accordingly, the cooking appliance can serve as a hood that sucks air discharged from the heating cooking device disposed below the cooking appliance and discharges the air to the outside.

The body 1010 can further include a front panel 1012 provided along an edge of an inlet of the cavity 1011. One surface of the front panel 1012 faces one surface of a choke member when the digital controller door 100 is closed, thereby closing the cavity 1011.

The front panel 1012 can be constructed to surround the edge of the inlet of the cavity 1011 and protrude in a frontward direction and has a predetermined width. Accordingly, when the digital controller door 100 is closed, the edge portion of the digital controller door 100 and the cavity 111 can overlap each other.

Due to this structure, the front panel 1012 can seal the cavity 1011 in a state in which the digital controller door 100 has been closed, thereby preventing oil, moisture, oil vapor, etc. generated during the cooking process of the food placed in the cavity 1011 from being leaked out to the outside through the inlet of the cavity 1011.

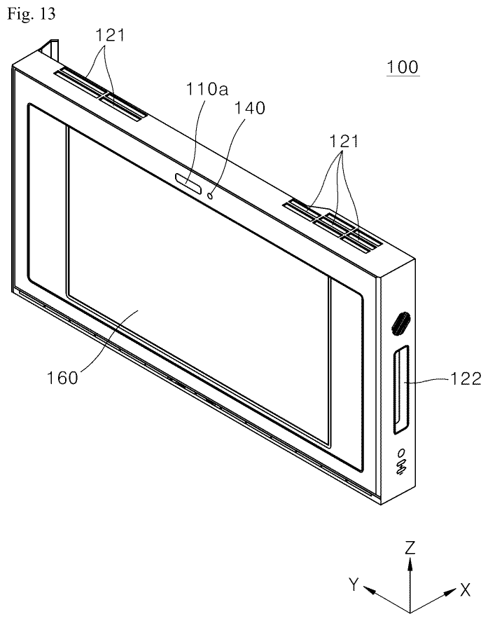

FIG. 13 is a perspective view illustrating a digital controller door of a cooking appliance according to an embodiment of the present disclosure.

The digital controller door 100 (e.g., display door) can include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 11 to 13, a reference numeral 121 denotes a through hole through which air is introduced or discharged. A first camera 110a and the sensor 140 can be disposed on the front surface of the digital controller door 100. The sensor 140 includes a human sensor, an illuminance sensor, etc.

The display 160 is used to control the cooking appliance 1000 or displays an operation process in the cooking appliance 1000. The ventilation hole 1013 can include a suction portion defined at a lower end of the body 1010 and a discharge portion defined at an upper end of the body 1010. A handle 122 is disposed on one side of the digital controller door 100 such that the user can open and close the digital controller door 100 using the handle.

A second camera 110b can be disposed on an inner side surface of the digital controller door 100, and the second camera 110b can photograph the inside of the cavity 1011 to check the cooking state.

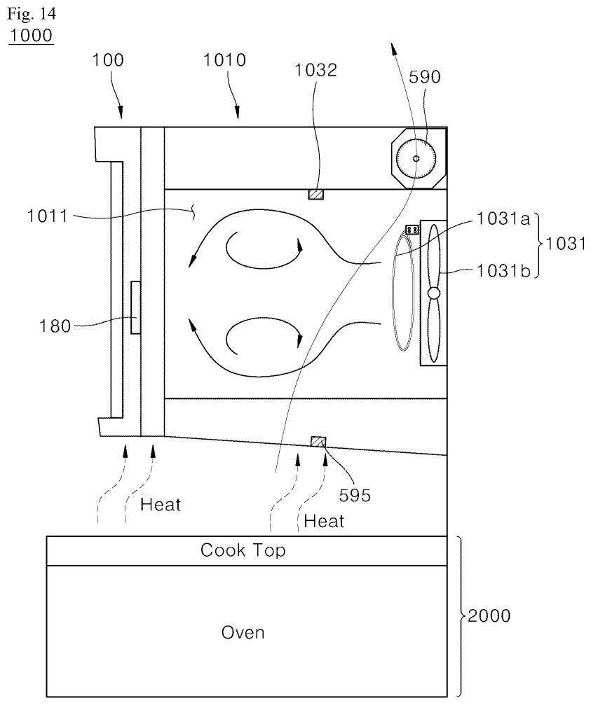

FIG. 14 is a schematic view illustrating a position where a cooking appliance is disposed according to an embodiment of the present disclosure. In FIG. 14, the flow of air is indicated by a solid line arrow, and the transfer direction of heat is indicated by a dashed line arrow. A heating cooking device 2000 can include, for example, an oven and a cooktop disposed on top of the oven.

The cooking appliance can include a convection-based heating device 1031 and a microwave generating device 1032 to heat food accommodated in the cavity 1011.

The convection-based heating device 1031 can generate heat to heat food, and the microwave generating device 1032 can generate microwaves to heat food. The user can select and operate one of the convection-based heating device 1031 or the microwave generating device 1032 to heat and cook food.

The convection-based heating device 1031 can include a convection heater 1031a and a convection fan 1031b. The convection heater can generate heat to heat food accommodated in the cavity 1011. The convection fan 1031b can force the air in the cavity 10 11 heated by the convection heater 1031a to flow in the cavity 1011.

When the convection fan 1031b operates, the heated air can be smoothly convectively circulated in the cavity 1011, and accordingly, heat is uniformly supplied to the entire cavity 10 11, so that an entirety of the food accommodated in the cavity 1011 can be evenly cooked.

In order to prevent the display 160 provided in the digital controller door 100 from being overheated by the heated air coming up from the heating cooking device disposed under the cooking appliance, resulting in malfunction of or damage to the display 160, it is necessary to cool the display 160 and prevent external heat from being transferred to the display 160. The door fan 180 and the ventilation fan 590 can perform the above role.

The door fan 180 can be disposed inside the digital controller door 100 (e.g., the door fan can be inside the smart display door). The door fan 180 can effectively cool the display 160 by flowing air toward the rear surface of the display 160.

In addition, the air flow discharged from the door fan 180 to the outside of the digital controller door 100 (e.g., display door) can form an air curtain to block the heat rising from the heating cooking device disposed under the cooking appliance.

The ventilation fan 590 can be disposed at a top of the body 1010 and can be disposed in a flow path of the ventilation hole 1013. The ventilation fan 590 can allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 160 of the digital controller door 100 can be relatively reduced. As a result, the flow rate of the heated air directed to the display 160 of the digital controller door 100 (e.g., display door) is reduced, thereby suppressing overheating of the display 160.

In order to block overheating of the display 160, it can be desirable to appropriately use the door fan 180 and the ventilation fan 590. Since one of main purposes of the door fan 180 is to prevent the overheating of the display 160, the door fan 180 can operate in a low-speed rotation mode and a high-speed rotation mode based on the temperature condition of air approaching the digital controller door 100.

The door fan 180 has a small amount of air blown in the low-speed rotation mode and a large amount of air blown in the high-speed rotation mode. Therefore, the temperature of the display 160 can be effectively lowered by the door fan operating in the low-speed rotation mode when the temperature of the air is low and by the door fan operating in the high-speed rotation mode when the temperature of the air is high.

In order to reliably suppress the overheating of the display 160, it is advantageous to operate both the door fan 180 and the ventilation fan 590 and operate the door fan 180 in the high-speed rotation mode.

The thermistor 595 disposed at a bottom of the cooking appliance 1000 can sense the heat from the heating cooking device disposed under the cooking appliance 1000. In addition, the auto ventilation function can operate upon sensing the heat.

In another embodiment of the present disclosure, the function controller and the OS controller can be implemented in a single controller, e.g., the function controller and the OS controller can be implemented in a single board. In this situation, there is one controller based on one board, and a function controller section and an OS controller section can be implemented in the single controller, respectively.

In addition, a memory required for an operation of each function can be defined such that different memory addresses used by different controller sections are allocated in one memory, or a separate memory can be assigned to each controller section.

According to some embodiments of the present disclosure, the controller can be implemented as one piece of hardware or the controller can be implemented as multiple pieces of hardware.

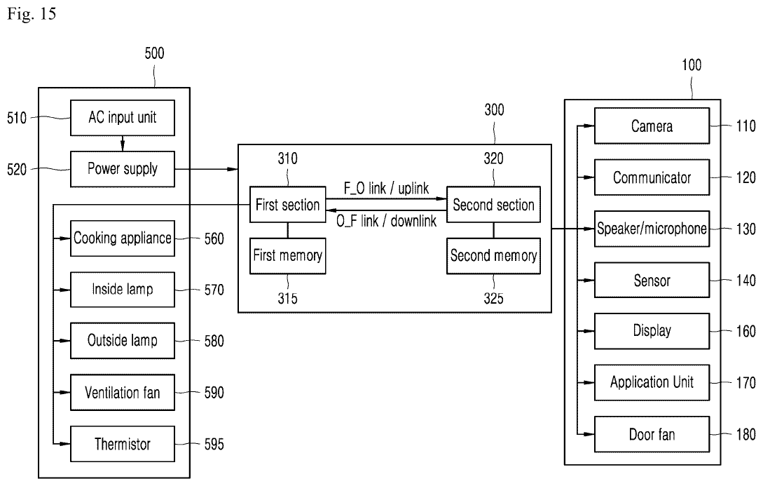

FIG. 15 is a diagram showing a configuration in which one controller controls a functional unit (e.g., cooking device or main portion) and a digital controller door (e.g., display door) according to one embodiment of the present disclosure.

A controller 300 includes a first section 310 that controls the functional unit 500 and a second section 320 that controls the digital controller door 100. Each section can write and read data to and from each of allocated memories 315 and 325 thereto. The first section 310 can write and read data using the first memory 315. The second section 320 can write and read data using the second memory 325.

The sections are functionally divided. One chip constituting the controller 300 can perform a function of the first section 310 and a function of the second section 320. Alternatively, two chips constituting the controller 300 can perform the functions of the first section 310 and the second section 320, respectively. Alternatively, some of the chips that constitute the controller 300 can perform the function of the first section 310 and others thereof can perform the function of the second section 320.

Alternatively, the controller 300 can be implemented with one software or can be implemented with multiple software. Alternatively, the controller 300 can include a hardware configuration that enables the operation of one or more software.

In one embodiment of the present disclosure, a data link is established between the two sections and data can be transmitted and received through the link. A F_O link or an uplink is a link through which the first section 310 transmits data to the second section 320. An O_F link O_F link or a downlink is a link through which the second section 310 transmits data to the first section 310.

In another embodiment of the present disclosure, one link is established between the two sections and data can be transmitted and received through the one link.

According to one embodiment of the present disclosure, the controller 300 can be disposed in the digital controller door 100 (e.g., inside the display door).

According to another embodiment of the present disclosure, the controller 300 can be disposed in the functional unit 500 (e.g., inside the cooking device or main body of the cooking device).

According to still another embodiment of the present disclosure, the controller 300 can be disposed in a separate terminal or in another home appliance.

The controller 300 can control the functional unit 500 and the digital controller door 100, and can restrict the operation of one or both of the functional unit 500 or the digital controller door 100 or cancel the function in operation depending on the transmission/reception status of the packet transmitted/received between the functional unit 500 and the digital controller door 100.

In this regard, the controller 300 can first cancel only the function that should be canceled (stopped) among the functions of the functional unit 500 and the digital controller door 100, and can maintain or cancel the other auxiliary functions among the functions of the functional unit 500 and the digital controller door 100.

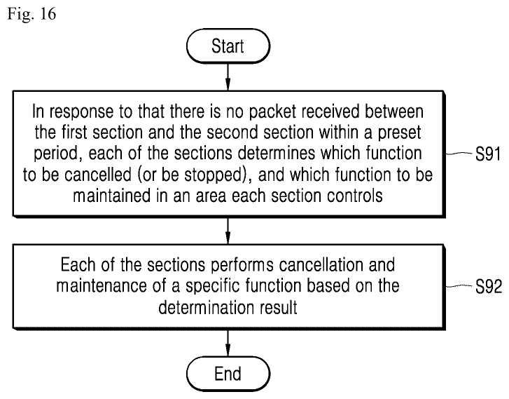

FIG. 16 is a diagram showing a process in which a controller controls the function of a cooking appliance according to one embodiment of the present disclosure.

In response to no packet being received between the first section 310 and the second section 320 within a preset period, each of the sections 310 and 320 can determine which function to be cancelled (or be stopped), and which function to be maintained in an area each section controls in S91.

Then, each of the sections 310 and 320 can perform cancellation and maintenance of a specific function based on the determination result in S92.

Which function to be canceled and which function to be maintained can be preset. In addition, each of the sections 310 and 320 can determine cancellation or maintenance of a specific function based on a value set by the user to the cooking appliance or a history of cancellation (stops), or maintenance of the specific function of the cooking appliance in the past.

In one embodiment, the first section 310 of the controller 300 can perform a follow-up task when there is no packet received from the second section 320 controlling the digital controller door 100 within a preset period.

In one embodiment, in response to no packet being received from the second section 320 for a preset period of time in S91, the first section 310 can cancel the cooking function performed by the functional unit 500 and maintain or cancel the auxiliary function performed by the functional unit 500 according to the preset value.

The cooking function is a function related to heating, etc. The auxiliary function is a function related to the operation of one or more additional components other than the cooking function.

As described above, in one example, the preset value includes a value set by the user to the cooking appliance or a value of the history of cancellation (stop), or maintenance of the specific function of the cooking appliance in the past.

When the user sets the inside lamp 570 or the outside lamp 580 to be turned on even when the cooking of the cooking appliance is canceled, the first section 310 can determine to maintain the on state of the lamp in the S91/S92 process. Alternatively, the first section 310 can maintain or cancel the operation of the ventilation fan 590. When the ventilation fan 590 is in the auto ventilation state, the first section 310 can maintain the operation state of the ventilation fan 590.

In the past, when the cooking function of the cooking appliance has been canceled due to a problem in transmitting and receiving, the user turned the turned-off lamp back on. This past history can be stored in the memory. In this situation, the first section 310 can determine to maintain the lamp in a turned on state in the S91/S92 process.

In another embodiment, in response to no packet being received from the first section 310 for a preset period of time, the second section 320 cancels the cooking function of the functional unit 500 and a first function of the digital controller door 100. The second section 320 maintains or cancels the auxiliary function performed by the functional unit 500 and a second function of the digital controller door 100.

In this regard, the first function is a function that should be canceled when there is no packet received from the functional unit 500. The second function is a function that can be selectively canceled or maintained when there is no packet received from the functional unit 500.

This can be selectively applied according to a preset value. In addition, in response to a user selecting a specific function through the interface of the digital controller door 100, the specific function can be canceled or maintained.

In one example, the first section 310 or the second section 320 can apply a priority in canceling the function.

For example, based on a function (such as a cooking function or the first function) which should be canceled at a first level priority and a function (such as an auxiliary function or the second function) that should be canceled at a next cancel priority, the first section 310 or the second section 320 can first cancel a specific function having the first cancel priority, and then cancel a function having the next cancel priority (e.g., second cancel priority).

In addition, the cancellation schemes or the monitoring/waiting time durations can be different from each other based on different sections.

For example, the first section 310 can immediately cancel the operation of the functional unit 500 in response to no packets being received from the second section 320 during a preset period.

Further, in response to there are being no packets received from the first section 310 during a preset period, the second section 320 can check whether there are any packets received from the first section 310 during the error determination time duration, and then, cancel the function of the digital controller door 100. The error determination time duration includes the time duration for which a task such as requesting re-transmission of a response packet in response to there being no reception after transmitting a monitoring packet is performed.

In this regard, the operation of the functional unit 500 is directly related to cooking. Thus, in response to there being no received packet, the first section 310 immediately cancels the operation of the functional unit 500. In addition, the operation of the digital controller door 100 is not directly related to cooking. Thus, in response to there being no received packet, the second section 320 can perform an additional work and then, cancel the operation of each of the digital controller door 100 (e.g., display door) and the functional unit 500.

According to one embodiment of the present disclosure, the function controller 550 can perform an immediate cancellation mechanism or the OS controller 200 (e.g., door controller) can perform a suspended cancellation mechanism depending on the transmission and reception status of the packet transmitted and received between the function controller 550 controlling the functional unit 500 and the OS (Operating System) controller 200 controlling the digital controller door 100.

The immediate cancellation mechanism is a mechanism in which the function controller 550 cancels the operation of each of the components of the functional unit 500.

The function controller 550 can check the reception status of the packets during the normal state monitoring time duration. In response to no packets being received during the normal state monitoring time duration, the function controller 550 can cancel the operation of each of the components of the functional unit 500.

Alternatively, the function controller 550 (e.g., main controller) can check the packet reception status during the normal state monitoring time duration. Then, when the packet is not received during the normal state monitoring time duration, the function controller 550 can immediately cancel the operation of the cooking appliance function provider 560, and can re-check the packet reception status or perform a function to resolve the error during the error determination time duration.

The suspended cancellation mechanism is a mechanism in which the OS controller 200 performs monitoring or waits for a preset time duration and then, cancels the operation of the component of the digital controller door 100.

The OS controller 200 can check the packet reception status during the normal state monitoring time duration and when the packet is not received during the normal state monitoring time duration, the OS controller 200 can re-check the packet reception status or perform a function to resolve the error during the error determination time duration.

In addition, when no packet is transmitted or received between the function controller 550 and the OS controller 200 for a preset period, the function controller 550 or the OS controller 200 can reset the communication channel. Both components 550 and 200 can check the packet transmission/reception error status and can reset the communication channel based on the checking result.

An embodiment of the present disclosure in which all the components are combined with each other or operate in combination with each other has been described. However, the present disclosure is not necessarily limited to this embodiment. Within the scope of the purpose of the present disclosure, at least two of all components can be selectively combined with other or can operate in the selectively combined manner with other. Furthermore, each of the components can be implemented as an independent hardware. However, some or all of the components can be selectively combined with each other and thus can be implemented using a computer program with a program module to perform some or all of the functions combined in one or more pieces of hardware. The codes and code segments that constitute the computer program can be deduced by a person skilled in the art from the present disclosure. The computer program can be stored in computer readable media and read and executed by a computer, thereby implementing the method of the present disclosure. The storage media for storing the computer program can include non-transitory storage media including magnetic recording media, optical recording media, and semiconductor recording devices. Additionally, the computer program implementing an embodiment of the present disclosure includes a program module transmitted in real time through an external device.

Although the embodiments of the present disclosure have been described in more detail with reference to the accompanying drawings, the present disclosure is not necessarily limited to these embodiments, and can be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A cooking appliance, comprising:
a main portion including a cavity for receiving food, and one or more functional components, the main portion being configured to provide a cooking function;
a display door coupled to the main portion, the display door including a display configured to provide a user interface, and one or more door-mounted peripheral devices;
a door controller configured to:
control an operation of the display door; and
a main controller configured to:
monitor a communication between the main controller and the door controller,
in response to a communication error occurring between the main controller and the door controller, perform at least one of a restriction operation to restrict at least one of the one or more functional components of the main portion, a reset operation to reset the door controller and turn off the display, and a report generation operation to store information related to the communication error.

2. The cooking appliance of claim 1, wherein the main controller is further configured to:
transmit a monitoring request packet to the door controller,
determine whether a monitoring response packet has been received from the door controller within a predetermined amount of time after transmission of the monitoring request packet, and
in response to the predetermined amount of time elapsing without the monitoring packet being received by the main controller, perform at least one of a cooking cancelation operation to cancel a cooking function of the main portion and the reset operation to reset the door controller.

3. The cooking appliance of claim 2, wherein the main controller is further configured to:
in response to the main portion currently performing a cooking operation, adjust the predetermined amount of time based on at least one of a course or temperature related to the cooking operation, a remaining time until completion of the cooking operation, and a past error occurrence record of the door controller.

4. The cooking appliance of claim 1, wherein the main controller is further configured to:
in response to the communication error occurring between the main controller and the door controller, perform the restriction operation to restrict the at least one of the one or more functional components of the main portion while allowing another one of the one or more functional components to continue operating in an active state.

5. The cooking appliance of claim 1, wherein the one or more functional components of the main portion includes at least one of a ventilation fan, an internal cavity lamp, an external lamp, an internal camera, a microwave generator, a turntable motor, and a heating element.

6. The cooking appliance of claim 1, wherein the main controller is disposed in the main portion of the cooking appliance, and
wherein the door controller is disposed in the display door, the door controller being separate from the main controller.

7. The cooking appliance of claim 1, wherein the main controller and the door controller are different sections of a same microchip, or different sections of a same printed circuit board.

8. A cooking appliance, comprising:
a main portion including a cavity for receiving food, and one or more functional components, the main portion being configured to provide a cooking function;
a display door coupled to the main portion, the display door including a display configured to provide a user interface, and one or more door-mounted peripheral devices;
a main controller configured to:
control an operation of the main portion; and
a door controller configured to:
monitor a communication between the door controller and the main controller,
in response to a communication error occurring between the door controller and the main controller, perform at least one of a channel reset operation to reset a communication channel between the controller door and the main controller, a cancelation operation to cancel a function currently being executed by the main portion, and an error display operation to display an error message on the display of the display door.

9. The cooking appliance of claim 8, wherein the door controller is further configured to:
transmit a transmission packet to the main controller,
determine whether a response packet has been received from the main controller within a predetermined amount of time after transmission of the transmission packet, and
in response to the predetermined amount of time elapsing without the response packet being received by the door controller, perform at least one of the channel reset operation to reset the communication channel between the controller door and the main controller, and the error display operation to display the error message.

10. The cooking appliance of claim 9, wherein the door controller is further configured to:
adjust the predetermined amount of time based on at least one of a course or temperature related to a cooking operation being performed by the main portion, a remaining time until completion of the cooking operation, and a past error occurrence record of the main controller.

11. A method of controlling a cooking appliance, the method comprising:
displaying a user interface by a display of a display door that is coupled to a main portion of the cooking appliance, the main portion including a cavity for receiving food, and one or more functional components;
controlling, by a door controller, an operation of the display door;
monitoring, by a main controller, a communication between the main controller and the door controller; and
in response to a communication error occurring between the main controller and the door controller, performing by the main controller at least one of restricting at least one of the one or more functional components of the main portion, resetting the door controller, and generating a report to store information related to the communication error.

12. The method of claim 11, further comprising:
transmitting, by the main controller, a monitoring request packet to the door controller;
determining, by the main controller, whether a monitoring response packet has been received from the door controller within a predetermined amount of time after the transmitting of the monitoring request packet; and
in response to the predetermined amount of time elapsing without the monitoring packet being received by the main controller, performing at least one of canceling a cooking function of the main portion and resetting the door controller.

13. The method of claim 12, further comprising:
in response to the main portion currently performing a cooking operation, adjusting by the main controller the predetermined amount of time based on at least one of a course or temperature related to the cooking operation, a remaining time until completion of the cooking operation, and a past error occurrence record of the door controller.

14. The method of claim 11, further comprising
in response to the communication error occurring between the main controller and the door controller, restricting by the main controller the at least one of the one or more functional components of the main portion while allowing another one of the one or more functional components to continue operating in an active state.

15. The method of claim 11, wherein the one or more functional components of the main portion includes at least one of a ventilation fan, an internal cavity lamp, an external lamp, an internal camera, a microwave generator, a turntable motor, and a heating element.

16. The method of claim 11, wherein the main controller is disposed in the main portion of the cooking appliance, and
wherein the door controller is disposed in the display door, the door controller being separate from the main controller.

17. The method of claim 11, wherein the main controller and the door controller are different sections of a same microchip, or different sections of a same printed circuit board.

18. A method of controlling a cooking appliance, the method comprising:
displaying a user interface by a display of a display door that is coupled to a main portion of the cooking appliance, the main portion including a cavity for receiving food, and one or more functional components;
controlling, by a main controller, an operation of the main portion;
monitoring, by a door controller, a communication between the main controller and the door controller; and
in response to a communication error occurring between the door controller and the main controller, performing by the door controller at least one of resetting a communication channel between the controller door and the main controller, canceling a function currently being executed by the main portion, and displaying an error message on the display of the display door.

19. The method of claim 18, further comprising:
transmitting, by the door controller, a transmission packet to the main controller;
determining, by the door controller, whether a response packet has been received from the main controller within a predetermined amount of time after the transmitting of the transmission packet; and
in response to the predetermined amount of time elapsing without the response packet being received by the door controller, performing by the door controller at least one of resetting the communication channel between the controller door and the main controller, and displaying the error message.

20. The method of claim 18, further comprising:
adjusting, by the door controller, the predetermined amount of time based on at least one of a course or temperature related to a cooking operation being performed by the main portion, a remaining time until completion of the cooking operation, and a past error occurrence record of the main controller.

21. A cooking appliance comprising:
a main portion configured to provide a cooking function, wherein the main portion includes a main controller for controlling an operation of the main portion; and
the display door, wherein the display door includes an door controller for controlling the display door,
wherein the main controller and the door controller are configured to transmit or receive a packet to or from each other,
wherein the main controller or the door controller is configured to restrict a function of the main portion or a function of the display door, or to cancel a function being currently executed, based on a transmission and reception status of the packet between the main controller and the door controller.

22. The cooking appliance of claim 21, wherein the main controller or the door controller is configured to:
check a reception status of the packet during a normal state monitoring time duration; and
in response to that no packet is received during the normal state monitoring time duration, re-check the reception status of the packet during an error determination time duration or solve an error.

23. The cooking appliance of claim 21, wherein the main controller or the door controller is configured to store, in an internal memory thereof, a record during a period during which the packet does not communicate between the door controller and the main controller,
wherein when the packet starts to communicate between the door controller and the main controller, the main controller and the door controller are configured to transmit the records respectively stored in the internal memories thereof to each other.
